(19) United States
(12) Patent Application Publication
(10) Pub. No.: US 2013/0339998 A1
(43) Pub. Date: Dec. 19, 2013

(54) SYSTEMS AND METHODS FOR PROVIDING RELATED MEDIA CONTENT LISTINGS DURING MEDIA CONTENT CREDITS

(71) Applicants: Jonathan Arme, Frankfort, IL (US); Mycal Elliott, Chicago, IL (US)

(72) Inventors: Jonathan Arme, Frankfort, IL (US); Mycal Elliott, Chicago, IL (US)

(73) Assignee: UNITED VIDEO PROPERTIES, INC., Santa Clara, CA (US)

(21) Appl. No.: 13/525,595

(22) Filed: Jun. 18, 2012

(51) Int. Cl. H04N 21/43

(52) U.S. Cl. 725/32

(57) ABSTRACT

Methods and systems for providing a media guidance application, which provides media listings during the credits accompanying a work. The media guidance application may automatically retrieve listings of related works (e.g., movies, television shows, webcasts, etc.) featuring the individual member of the cast or crew of the work and supplement or replace each cast or crew member's name with listings for the related works.

### BACKGROUND OF THE INVENTION

In conventional systems, credits often appear before (opening credits) or after (end credits) a motion picture, television program, video game, or similar works. The credits list the entities involved in the production of the work (e.g., the cast, crew, director, producer, production company, animation studio, etc). Opening credits are often shown as text superimposed over opening scenes of the work. End credits usually appear as a list of names, which crawl, or move smoothly across, the background or a black screen. Credits may crawl across the screen either right-to-left or bottom-to-top, which is typical of North American films.

In many cases, the credits present the only chance for a viewer to determine the entities involved in the production of the work. Unfortunately, credits typically include a large amount of text, usually in small print, and displayed quickly. Therefore, credits are typically difficult for a viewer to read. Furthermore, the display of credits is often adjusted to decrease the time for the credits to roll (e.g., by increasing the speed at which the credits crawl), or to decrease the display area of the credits (e.g., by decreasing the size of the window in which the credits are displayed). Therefore, it is difficult for a viewer to determine the names of the entities for which they may wish to view in similar works. In addition, in order for a viewer to use this information to determine other works featuring the same entities, a viewer would need to quickly record and cross-reference each name while the credits roll.

### SUMMARY OF INVENTION

Accordingly, methods and systems are described herein for providing a media guidance application, which provides media listings during the credits accompanying a work. The media guidance application may automatically retrieve listings of related works (e.g., movies, television shows, webcasts, etc.) featuring the individual member of the cast or crew and supplement or replace each cast or crew member's name with listings for the related works. For example, as an actor's name appears during the crawl of the credits of movie, other movies featuring the actor may appear in a pop-up window accompanying the actor's name.

In some embodiments, the name and information of listings of the other works may be featured as a pop-up display or window. The pop-up display or window may be displayed automatically, which allows the viewer to browse the information in the pop-up display or window without having to return to a guide screen or exit the display of the credits. In some embodiments, the size and position of the pop-up display or window may depend on the contents of media asset (e.g., the size and position of the credits). The media guidance application may account for the pop-up display or window by re-sizing the display of the credits, may overlay the pop-up display or window on top of the display of the credits, or may position the pop-up display or window around the credits.

In some embodiments, the media guidance application may detect credits appearing in the program via triggers transmitted with the program. The media guidance application may receive tags with code transmitted with the media asset (e.g., a movie). For example, metadata associated with the program or information transmitted in the vertical blanking intervals of a transmission may alert the media guidance application to the presence of credits. By processing the metadata, the media guidance application may provide real-time display of other works featuring the entities in the credits as the entities name crawls across the screen.

In some embodiments, the media guidance application may detect credits appearing in the program via a mapping associated with the media asset. For example, the media guidance application may retrieve a mapping, which indicates the name and location a particular entity may appear in the media asset. By processing the mapping, the media guidance application may provide real-time display of other works featuring the entities in the credits as the entities name crawls across the screen.

In some embodiments, the listing of the other work may include a picture or video, and, in some embodiments, the viewer may select the listing to retrieve the media content associated with the listing, receive additional information regarding the media content, or obtain scheduling and/or purchasing information for the media content. In some embodiments, the pictures or videos associated with the listing are retrieved from remote storage equipment and cached on local storage equipment to reduce lag.

In some embodiments, the media guidance application may link two devices, which act in concert to provide a single user experience. For example, in some embodiments, the media guidance application may display related media content listings on the display screen of one device, while the credits appear on the display screen of another device.

In some embodiments, the listings provide the links to the media content, which may be stored remotely. For example, upon selection of a listing, the media guidance application may access a remote database containing the media content. In some embodiments, the listings may be navigable by a viewer. For example, a viewer may be able to scroll through several listings of related media content while the credits are paused or while the credits continue to crawl.

The media guidance application may compile related media content listings of other works featuring the cast and crew of the media asset currently being displayed, before or during the display of the media asset. In some embodiments, media content listings, as well as the links to the media content, for other entities in the credits may also be compiled (e.g., production companies, animation studios, sound stages, etc.). The compilation of the related media content listings and the links may be stored on a database. In some embodiments, the media guidance application may determine related media content listings for each entity in the credits through textual searches of databases containing information about the entities involved in producing media content.

In some embodiments, the media guidance application may retrieve the related media content listings, and establish the links to the related media content, upon detecting that the credits of a media asset are being displayed. The media guidance application may detect the credits by receiving a credit trigger, which indicates credits of the media asset are being shown. In some embodiments, the media guidance application may synchronize the display of the related media content listings associated with an entity with the appearance of a name of that entity on the display, and, without further input by the user, the media guidance application may present the synchronized display on the display screen simultaneously with the names of the entities in the credits.

In some embodiments, display of the related media content listings may be removed from the display screen when the name of the entity associated with the related media content listings is no longer displayed on the display screen (e.g., the entity's name has crawled off-screen).

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application that may be used to display media content listings in accordance with some embodiments of the disclosure;

FIG. 2 shows an illustrative media guidance application that may be used to activate media content listings in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A shows an illustrative media listing displays that may be used to display related media content listings in accordance with some embodiments of the disclosure;

FIG. 5B shows an illustrative media listing displays that may be used to display related media content listings in accordance with some embodiments of the disclosure;

FIG. 5C shows an illustrative media listing displays that may be used to display related media content listings in accordance with some embodiments of the disclosure;

FIG. 6A is a flow-chart of illustrative steps involved for providing media content listings during the credits of a media asset in accordance with some embodiments of the disclosure;

FIG. 6B is a flow-chart of illustrative steps involved for providing media content listings during the credits of a media asset in accordance with some embodiments of the disclosure;

FIG. 7 shows an illustrative media listing displays that may be used to display related media content listings in accordance with some embodiments of the disclosure;

FIG. 8A shows an illustrative media listing displays that may be used to display related media content listings in accordance with some embodiments of the disclosure;

FIG. 8B shows an illustrative media listing displays that may be used to display related media content listings in accordance with some embodiments of the disclosure;

FIG. 8C shows an illustrative media listing displays that may be used to display related media content listings in accordance with some embodiments of the disclosure;

FIG. 8D shows an illustrative media listing display that may be used to display related media content listings in accordance with some embodiments of the disclosure;

FIG. 9 is a flow-chart of illustrative steps involved in compiling related media content listings for display during the credits of a media asset in accordance with some embodiments of the disclosure;

FIG. 10 shows an exemplary data structure for a compilation of data associated with an entity in a media asset in accordance with some embodiments of the disclosure;

FIG. 11 is a flow-chart of illustrative steps involved for receiving a credit trigger and displaying related media content listings during the credits of a media asset in accordance with some embodiments of the disclosure;

FIG. 12 shows an exemplary data structure for a data transmission associated with a media asset in accordance with some embodiments of the disclosure;

FIG. 13 shows an exemplary data structure for a data transmission associated with a media asset in accordance with some embodiments of the disclosure;

FIG. 14 is a flow-chart of illustrative steps involved for displaying related media content listings during the credits of a media asset according to a user profile in accordance with some embodiments of the disclosure;

FIG. 15 shows an exemplary data structure for a data transmission of user profile information in accordance with some embodiments of the disclosure;

FIG. 16 shows an exemplary data structure for data associated with a user profile in accordance with some embodiments of the disclosure;

FIG. 17A shows an exemplary data structure for related media content listings in accordance with some embodiments of the disclosure;

FIG. 17B shows an exemplary data structure for related media content listings related to an entity as filtered according to a user profile in accordance with some embodiments of the disclosure; and

FIG. 17C shows an exemplary data structure for related media content listings related to an entity as filtered according to a user profile in accordance with some embodiments of the disclosure.

### DETAILED DESCRIPTION

Methods and systems are described herein for providing a media guidance application, which provides media listings during the credits accompanying a media asset. The media guidance application may automatically display the names of other works (e.g., movies, television shows, webcasts, etc.) featuring an individual entity as the entity's name appears in the credits. In some embodiments, the media guidance application may supplement or replace the names of the entities with the names and information of the other works featuring the particular entity.

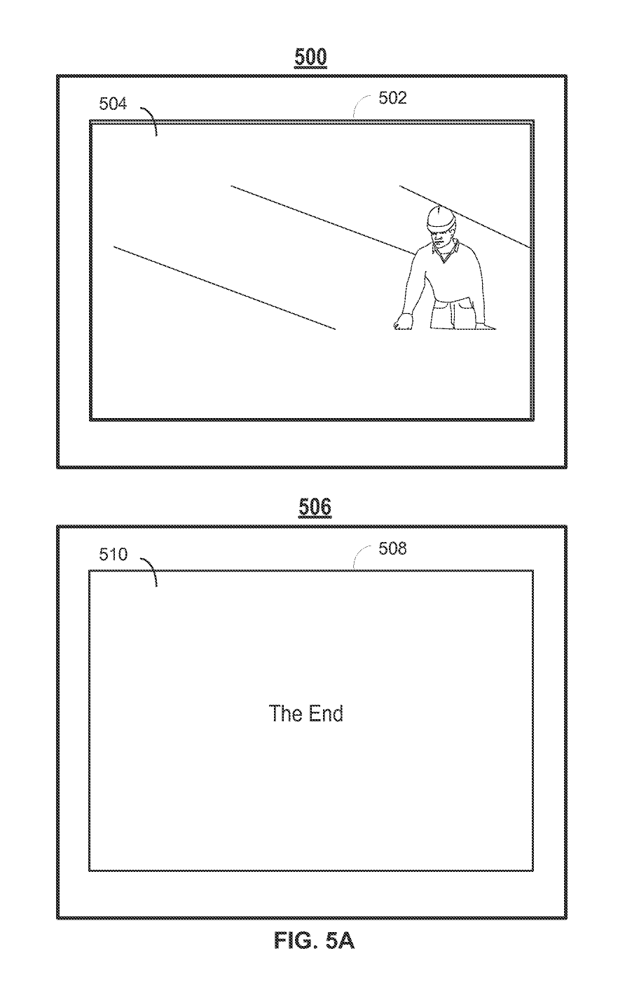

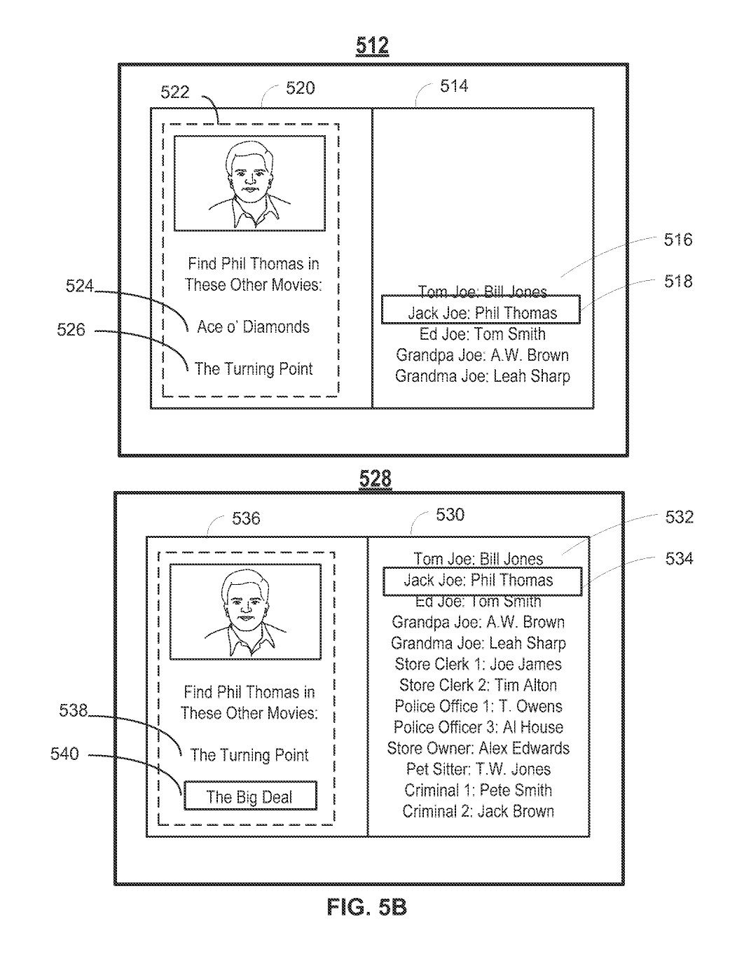

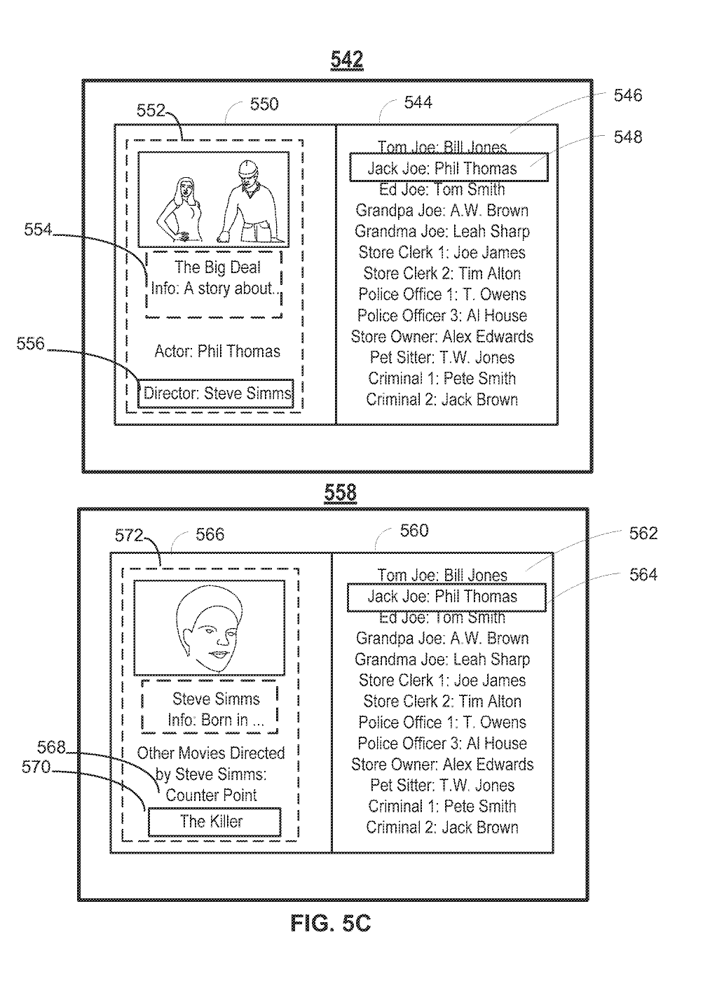

As used herein, an “entity” is any person, place, or thing that may be credited in the credits of media content, for which the media guidance application may provide related media content. An entity includes the cast and crew associated with media content as well as other companies, corporations, firms or businesses, including but not limited to, film studios, animation studios, special effects companies, sound stages, or any other body associated with the production of media content. In addition, entities may refer to products or services used in the media content. For example, the media guidance application may provide related media content listings that feature a particular song that is credited in the credits of the media asset. The media guidance application may provide related media content listings that feature the same location, for which a credit was given in the credits, as the media asset. In some embodiments, related media content listings and/or prompts (e.g., prompt 554 and related media content listing 556 (FIG. 5C)) may be supplemented or replaced by biographical information, textual information or other selectable content regarding the entity or another entity. For example, in some embodiments, a user may select a related media content listing for a particular media asset. The media guidance application may then provide a related media content listing profile featuring other entities associated with the media asset.

Credits typically include a large amount of text, usually in small print, which is displayed quickly. Consequently, many users desire a form of media guidance through an interface that allows users to efficiently navigate additional media content featuring the entities associated with media content the users are currently viewing. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As used herein, “related media content” refers to content that is associated with or contains similar features or traits to other media content or media assets. For example, two media assets may be related if the media assets both feature the same actor, actress, director, animation studio, or any other entity.

As used herein, “listings” or “media content listings” refer to an on-screen indication used to identify particular media content or a media asset. For example, a listing may include the name or title of the media asset, a picture of the media asset, a video associated with the media asset, or any other information that may indicate to the user the media asset associated with the listing.

As used herein, “credits” refer to a display or list of the entity or entities involved in the production of the work. For example, credits may appear before or after a movie or television show as a list of the cast and crew involved in the production of the movie or television. In some embodiments, credits may be accompanied by credit triggers. As used herein, a “credit trigger” is any information received by the media guidance application, which alerts the media guidance application to the presence of credits. One or more credit triggers may indicate the appearance of credits generally (e.g., the beginning of the crawl of the credits of a media asset on the display screen) or may indicate the appearance of a particular credit (e.g., the appearance of the name of a particular actor during the crawl of the credits).

In some embodiments, the media guidance application may detect credits appearing in the program via a mapping associated with the media asset. As used herein, a “mapping” is information received by the media guidance application that indicates the name and location of entities appearing in the media asset. The location of entities may refer to a specific time or place. For example, the media guidance application may retrieve a mapping, which indicates the name of an entity will appear at one hour and forty minutes into the run-time of a movie until one hour and forty-two minutes into the run-time of a movie. By processing the mapping, the media guidance application may provide real-time display of other works featuring the entities in the credits as the entities name crawls across the screen.

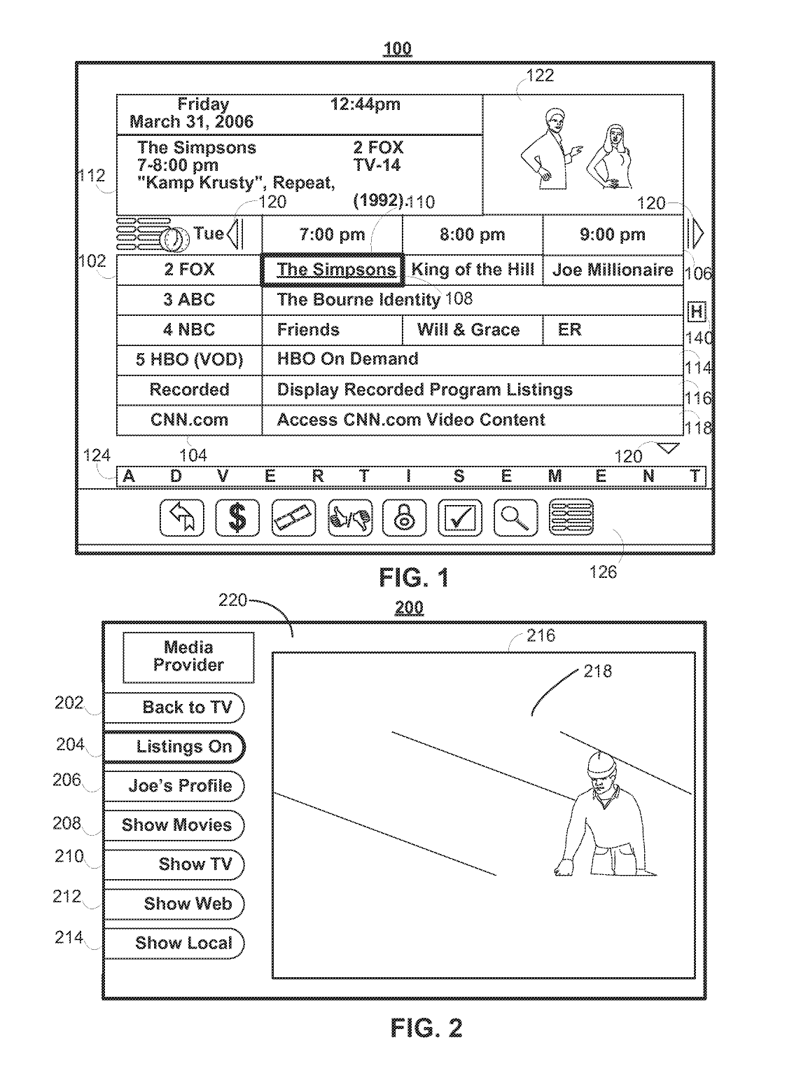

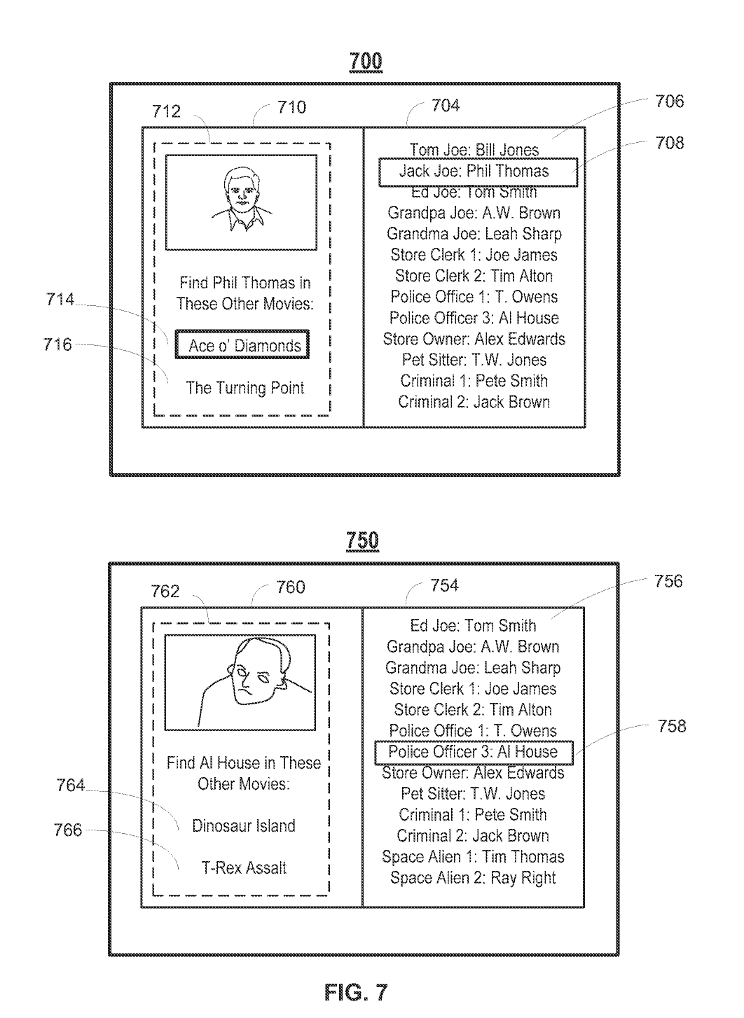

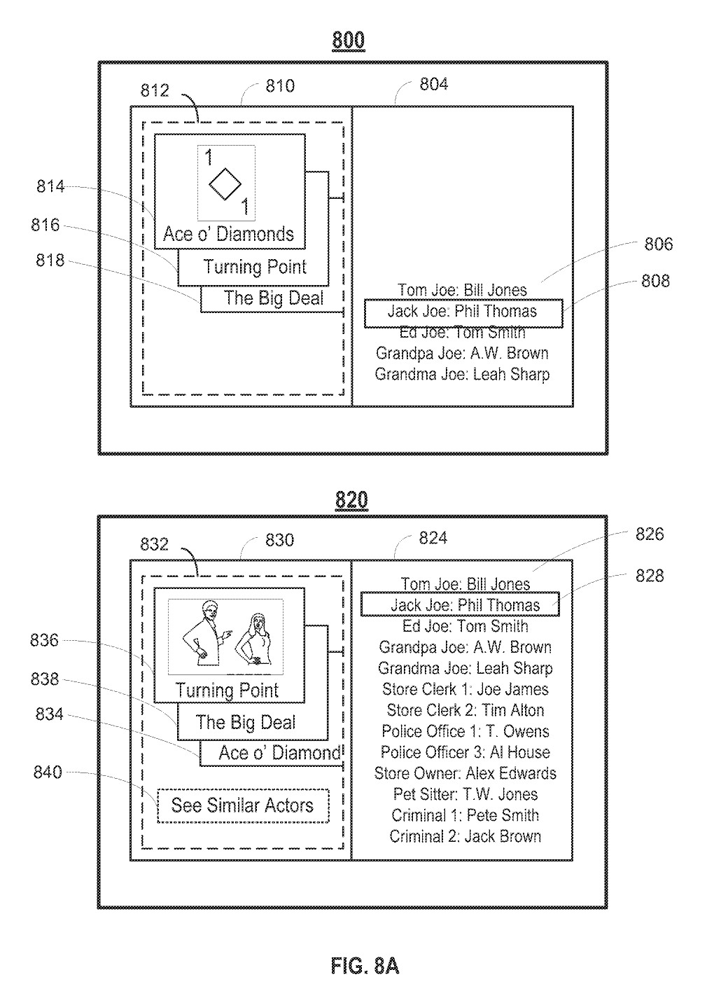

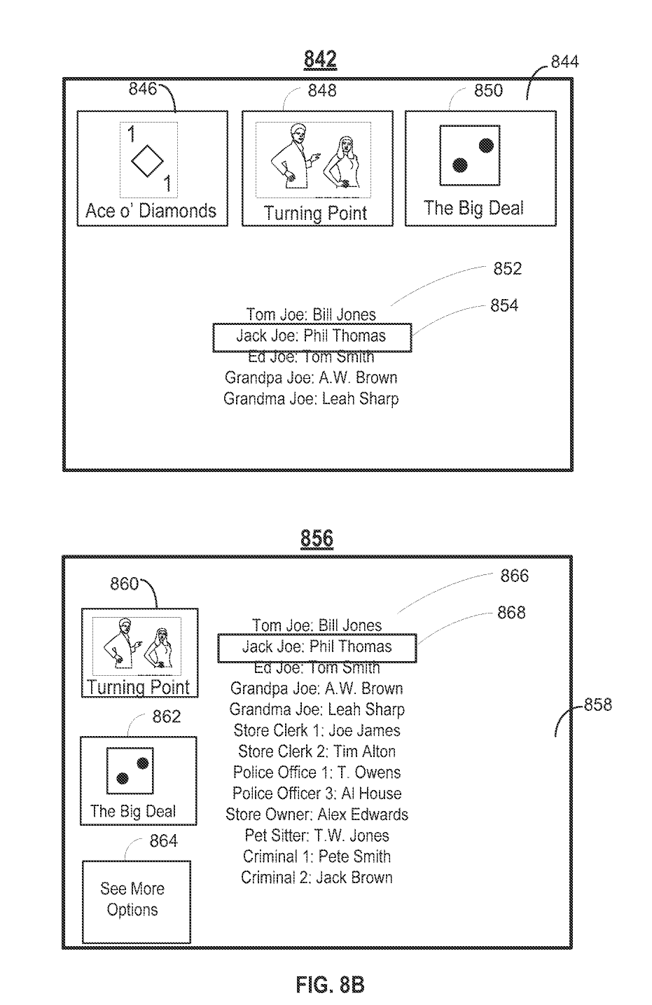

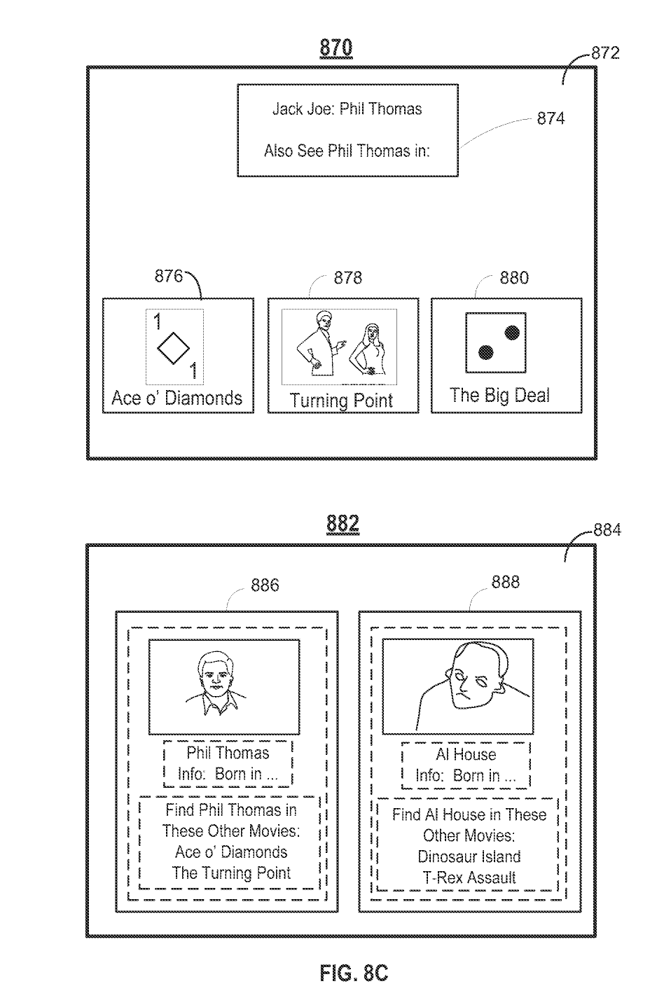

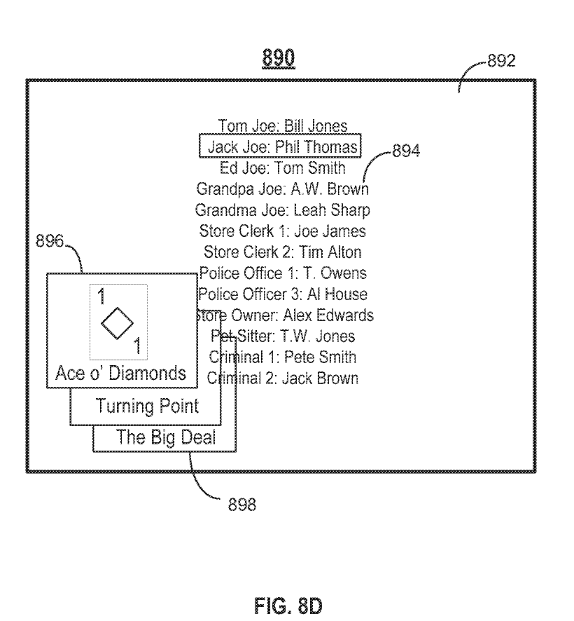

In some embodiments, the media guidance application may synchronize the display of the related media content listings associated with an entity with the appearance of the name of that entity on the display screen, and, without further input by the user, the media guidance application may present the synchronized display on the display screen simultaneously with the names of the entities in the credits. In some embodiments, display of the related media content listings may be removed from the display screen when the name of the entity associated with the related media content listings is no longer displayed on the display screen (e.g., the entity's name has crawled off-screen). It should be noted that throughout this disclosure that a display where used to refer to a display on user equipment (e.g., display 100 (FIG. 1), 200 (FIG. 2), 500 (FIG. 5A), 506 (FIG. 5A), 512 (FIG. 5B), 528 (FIG. 5B), 542 (FIG. 5C), 558 (FIG. 5C), 700 (FIG. 700), 750 (FIG. 7), 800 (FIG. 8A), 820 (FIG. 8A), 842 (FIG. 8B), 856 (FIG. 8B), 870 (FIG. 8C), 882 (FIG. 8C), 890 (FIG. 8D) may functions as and be used interchangeably with the term display screen.

In some embodiments, the name and information of media content that is related to the media asset currently being viewed by a user may be featured as a pop-up window or listing (e.g., as shown in FIGS. 5A, 5B, and 7-8D). The pop-up window, or related media content portion (e.g., related media content listings portion 520 (FIG. 5B), or listing (e.g., related media content listings 524 (FIG. 5B) may be displayed automatically, which allows the viewer to browse the information in the pop-up display or window without returning to a guide screen (e.g., FIGS. 1-2) or exit the display screen displaying the credits. In some embodiments, the pop-up display or window may appear automatically adjust its position on the display screen based on the position of the credits. The media guidance application may account for the window by re-sizing the display of the credits (e.g., as shown in FIG. 8A), by appearing adjacent to, or around, the credits (e.g., as shown in FIG. 8B), by replacing the credits entirely (e.g., as shown in FIG. 8C), or by appearing in an overlay with varying transparency (e.g., as shown in FIG. 8D). In some embodiments, the media guidance application may detect credits appearing in the program via triggers transmitted with the program. For example, metadata associated with the program or information transmitted in the vertical blanking interval (“VBI”) may alert the media guidance application that credits may be displayed on the display screen.

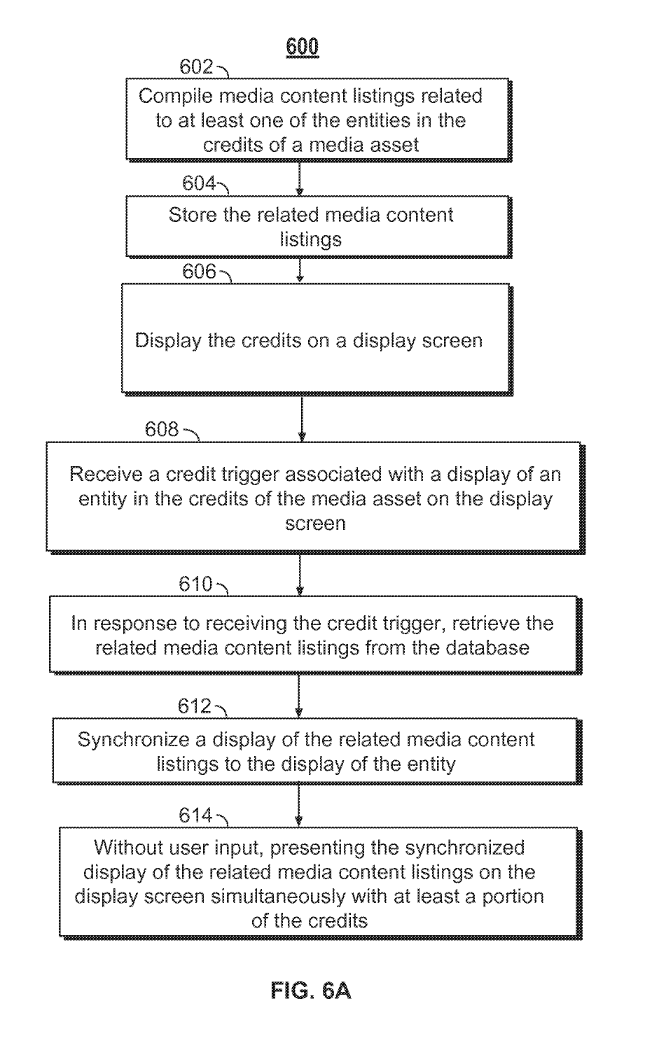

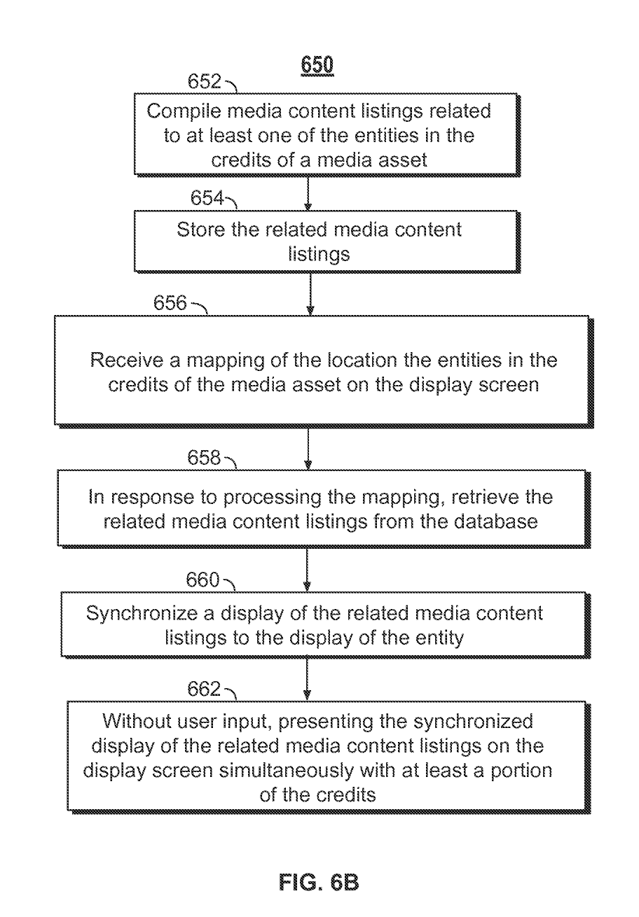

In some embodiments, the listing may include a picture or video associated with related media content listings (e.g., as shown in FIGS. 6-8D). The viewer may select the listings to retrieve the related media content, receive additional information regarding the related media content, or obtain scheduling and/or purchasing information for the related media content. These options may be available through links provided by or located by the media guidance application. In some embodiments, the related media content and the links to the related media content may be stored on a database (e.g., content source 416 (FIG. 4) and/or media guidance source 418 (FIG. 4)), which is accessed by the media guidance application.

In some embodiments, the listings may be navigable by a viewer (e.g., as shown in FIGS. 8A and 8B). For example, a viewer may be able to scroll through several listings of related media content while the credits are paused or while the credits continue to crawl. The scrolling operation may slide the related media content listings side-to-side (e.g., as shown in FIG. 8B), back-to-front (e.g., as shown in FIG. 8A), or any other adjustment of positioning. The scrolling operation may also highlight a particular listing (e.g., increasing the size of the related media content listing on the display screen, showing additional information regarding the related media content, presenting a preview of the related media content, or other operations, which display the listing more prominently than other listings).

The media guidance application may compile the media assets or links to the media assets of related media content listings. To compile the related media content listings, the media guidance application may search a variety of sources. As used herein, a “source” refers the anything from which media content information may be retrieved (e.g., a local or remote database or server). Media content information describes the entities associated with the media content, the subject matter of the media content, traits relating to the user's profile of the media content, or any other information used by the media guidance application to determine whether or not media content is related.

The media guidance application may search a variety of sources using any suitable method to compile the related media content listings as well as the links or media assets associated with those listings. In some embodiments, the media guidance application processes or scans for information such as the title, cast, crew, and/or any other entity in order to determine whether or not a particular listing is related to another listing. The media guidance application may also process or scan information to determine if the listing is of interest to a user. For example, the media guidance application may determine the particular genre of a listing and compare this information to information from a user's profile which indicates the genre the user prefers. When the media guidance application displays related media content, the related media content indicated to be of more interest to the user (e.g., based on comparisons with the user profile) may be more prominently displayed (e.g., displayed in front of other related media content, displayed to the left of other related media content, etc.).

To search and compare the different kinds of information, the media guidance application may use multiple types of object recognition, including fuzzy logic. For example, the particular information may be found in a data field that may be a textual data field. Using fuzzy logic, the system may determine two fields to be identical (or different) even though the substance of the data field (e.g., two different spellings of an actor's name) is not identical. In some embodiments, the media guidance application may analyze particular data fields of the first kind of information and the second kind of information for particular values or text. The data fields may include any information associated with the listing (e.g., entity names, categories, genres, series, episodes, products, traits, ratings, targeted audiences, textual descriptions, or any other suitable indicator regarding the content of the media asset). Furthermore, the data fields could contain values (e.g., the data fields could be expressed in binary or any other suitable code or programming language). Other suitable methods for comparing data are also contemplated by this disclosure.

In some embodiments, media content listings as well as the links to the media content (e.g., a media asset associated with the listings) may be compiled for any entities associated with the media content. Upon identifying related media content listings, the media guidance application may store the media assets and/or links to the media assets associated related media content listings. In some embodiments, the media guidance application may retrieve the related media content listings, and establish the links to the related media content, upon detecting that the credits of a media asset are being displayed. The media guidance application may also verify the validity of the links of media content prior to displaying the related media content listings.

In some embodiments, the credits and related media content listings may appear on a display screen of user equipment. As referred to herein, the phrase “user equipment device,” “user equipment,” “user device,” “electronic device,” “electronic equipment,” “media equipment device,” or “media device” should be understood to mean any device for accessing and/or displaying the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices.

In some embodiments, the media guidance application may link two devices, which act in concert to provide a single user experience. For example, in some embodiments, the media guidance application may display related media content listings on one device, while the credits appear on another device. The user may be able to scroll through the related media content listings, follow the links associated with the related media content, and/or view or purchase the media assets associated with related media content listings without disturbing the credits as displayed on another device. For example, one display screen on one device may show a media asset (e.g., media asset portion 520 (FIG. 5B) and a second display screen on a second device may show the accompanying related media content listings portion 520 (FIG. 5B).

The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content, such as media listings, displays of related media content, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

FIGS. 1-2 show illustrative display screens that may be used to provide media guidance data. The display screens shown in FIGS. 1-2 and 5A, 5B, 7-8D may be implemented on any suitable user equipment device or platform. While the displays of FIGS. 1-2 and 5A, 5B, 7-8D are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button or a SEE MORE LISTINGS button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to, or be unrelated to, one or more of the content listings in grid 102. Advertisement 124 may also be for products or services related, or unrelated to, the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other display screens of the embodiments described herein or accompanying, adjacent to, or interspersed with related media content listings.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. As used herein, a “user profile,” is a compilation of interests of a user generated by the user and/or a third party regarding media content. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com or a particular social network, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Display 200 displays guide 220, which includes selectable options 202, 204, 206, 208, 210, 212, and 214. Selectable options 202, 204, 206, 208, 210, 212, and 214 may allow a user to select different settings for the media guidance application. For example, the user may indicate, using option 204, that the media guidance application should always display related media content listings whenever credits are detected. Therefore, a user would not need to return to guide 220 in order for related media content listings to appear.

In some embodiments, the media guidance application may automatically provide related media content listings anytime credits are detected. For example, the related media content listings may appear whenever credits associated with a media asset appear on the display screen. In some embodiments, the media guidance application may display related media content listings according to a content provider, without user input. For example, a content provider may transmit the related media content listings with the media asset.

Guide 220 may provide graphical images including cover art, still images from the content, video clip previews, live video from the content, or other types of content that indicate to a user the content being described by the media guidance data in the listing. Guide 220 may also include media asset portion 216, which displays media asset 218. Media asset portion 216 may have a reduced size while the guide 220 is activated on display 200. In some embodiments, after a user exits the guide 220, media asset portion 216 may occupy all of display 200.

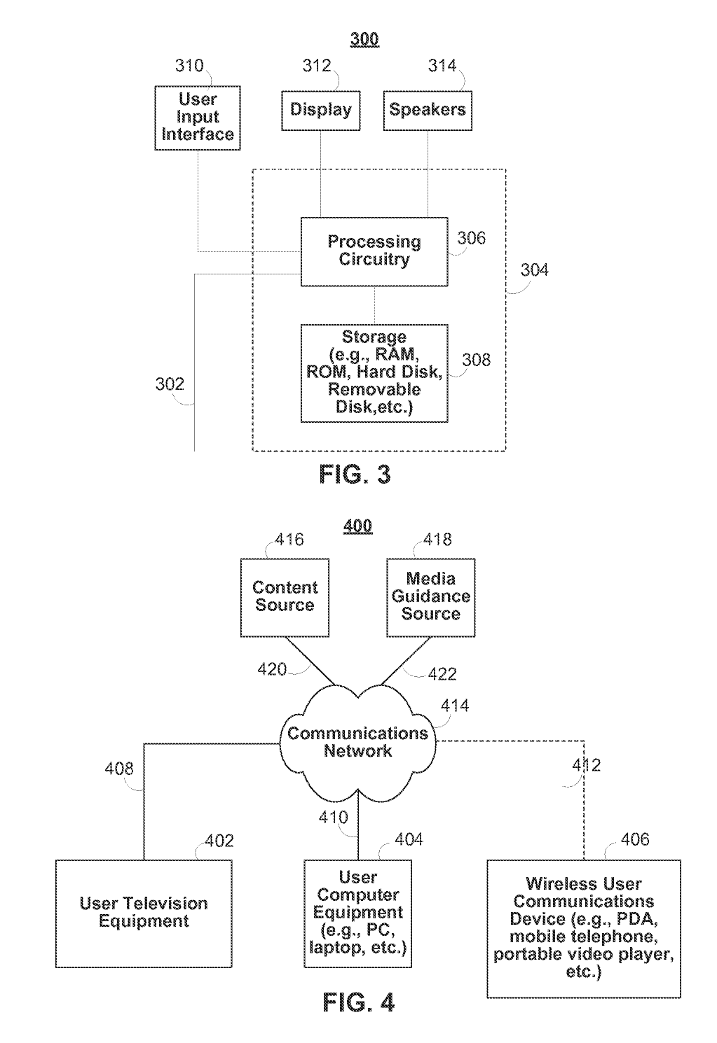

In some embodiments, guide 220 may be received from media guidance source 418 (FIG. 4) and media asset may be received from content source 416 (FIG. 4) via communications network 414 (FIG. 4). In some embodiments, control circuitry 304 (FIG. 3) may be used to executes commands in guide 220.

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4 and may be used to control or operate the media guidance application. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and, specifically, processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, a multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the related media content listings. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions (e.g., selecting or scrolling related media content listings) to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images.

In addition, intelligent detection systems may be used to input information into the graphical user interface without user input. Intelligent detection systems may include, but are not limited to, user proximity detection (e.g., detecting particular users that are within viewing distance of the device displaying the graphical user interface), remote identification of users (e.g., detecting personal identifiers, such as passwords, access codes, electronic signatures, keycards, which are registered to a person), or remote identification of devices, which indicate a user is present (e.g., identifying that a smartphone registered to a particular user is within a proximity suggests that the user is within the same proximity). Furthermore, intelligent detection systems may, based on the time of day, direct the control circuitry 304 to automatically select the profiles associated with particular users to determine a media content selection. In another example, intelligent detection systems may cross-reference the current data and time with devices featuring calendar devices to determine whether or not a particular user, related to a particular profile, is available.

In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304.

In some embodiments, display 312 may correspond to display 200 (FIG. 2), display 500 (FIG. 5A), display 506 (FIG. 5A), display 512 (FIG. 5B), display 528 (FIG. 5B), 542 (FIG. 5C), 558 (FIG. 5C), display 700 (FIG. 7), display 750 (FIG. 7), display 800 (FIG. 8A), display 820 (FIG. 8A), display 820 (FIG. 8A), display 842 (FIG. 8B), display 856 (FIG. 8B), display 870 (FIG. 8C), display 882 (FIG. 8C), and/or display 890 (FIG. 8D).

Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled, allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that, in the exemplary embodiment shown in FIG. 4, it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIGS. 5A, 5B, and 5C show illustrative media listing displays that may be used to display related media content listings in accordance with some embodiments of the disclosure. In some embodiments, display 500, display 506, display 512 (FIG. 5B), display 528 (FIG. 5B), display 542 (FIG. 5C), and display 558 (FIG. 5C) represent a series of display screens as viewed by a user. For example, display 500 may appear first followed by display 506. Upon the appearance of credits in display 512 (FIG. 5B), related media content listings also appear. It should be noted, in some embodiments, display 500, display 506, display 512 (FIG. 5B) and display 528 (FIG. 5B) may not represent a series of display screens as viewed by the user. For example, the display screens may be presented in different orders or without each of display 500, display 506, display 512 (FIG. 5B) and display 528 (FIG. 5B).

In some embodiments, display 500 may be preceded by display 200 (FIG. 2) and commands entered into selectable options 202, 204, 206, 208, 210, 212, and 214 may affect one or more of display 200 (FIG. 2), display 500, display 506, display 512 (FIG. 5B), display 528 (FIG. 5B), 542 (FIG. 5C) and 558 (FIG. 5C). In some embodiments, each of display 200 (FIG. 2), display 500, display 506, display 512 (FIG. 5B), display 528 (FIG. 5B), 542 (FIG. 5C), and 558 (FIG. 5C) may appear on user equipment 402, 404, and/or 406 (FIG. 4).

FIG. 5A shows illustrative media listing display 500 and display 506 that may be used to display related media content listings in accordance with some embodiments of the disclosure. Media asset portion 502 includes the portion of the display 500, which features the media asset 504. In some embodiments, media asset 504 may be received from content source 416 (FIG. 4). Display 506 shows the media asset portion 508 and media asset 510, which has reached the end of the featured presentation as indicated by the words “The End.”

FIG. 5B shows illustrative media listing display 512 and display 528 that may be used to display related media content listings in accordance with some embodiments of the disclosure. Display 512 includes media asset portion 514, which currently displays credits 516. In response to the appearance of credits 516, the media guidance application generates related media content listings portion 520. Related media content listings portion 520 currently displays related media content listings 524 and 526 in related media content listings profile 522, which correspond to “Phil Thomas” the entity 518 is highlighted in credits 516.

In some embodiments, entity 518 may be highlighted by the media guidance application to indicate the entity for which the related media content listings 524 and 526 in related media content listings portion 520 are associated. Highlighting may include any indication in media asset portion 514 that alerts a user to the fact that the related media content listings 524 and 526 in related media content listings profile 522 as shown in related media content listings portion 520 of display 512 are related to entity 518 in credits 516. For example, highlighting may include boxing, bolding, enlarging, changing the color, or otherwise graphically altering the particular name of the entity. In addition, multimedia indications may also be used. Also, in some embodiments, the media guidance application may not provide a highlight on entity 518.

In some embodiments, related media content listings profile 522 may include related media content listings 524 and 526. In addition, in some embodiments, related media content listings profile 522 may include additional information regarding entity 518. For example, related media content listings profile 522 may include an image, audio or video, or biographical information of entity 518. In addition, related media content listings profile 522 may include biographical information, textual information or other selectable content regarding entity 518. For example, related media content listings profile 522 may include a summary of the accomplishments, demographic information, or interesting facts regarding entity 518. In some embodiments, related media content listings (e.g., related media content listings 524 and 526) may be supplemented or replaced by biographical information, textual information or other selectable content regarding entity 518.

Display 528 includes a media asset portion 530. In media asset portion 530, credits 532 have continued to crawl from the position of credits 516. Entity 534, which may correspond to entity 518, now appears closer to the top of the media asset portion 530. In some embodiments, display 528 may represent the time progression of display 512 as the media asset shown in media asset portion 530 has continued to play and is now further progressed than the same media asset as shown in media asset portion 514.

Related media content listing portion 536 includes related media content listing 538 and related media content listings 540. In some embodiments, related media content listing 538 may correspond to related media content portion 520. Related media content listing 524 is no longer displayed in related media content listing portion 536. For example, a viewer using control circuitry 304 (FIG. 3) may have performed a scrolling operation. Related media content listing 524 may have been replaced with related media content listing 540. Related media content listing 540 is also indicated as being highlighted. In some embodiments, this may result from user input via control circuitry 304 (FIG. 3). In some embodiments, the media guidance application may direct or provide additional information (e.g., scheduling, ordering, and/or summary information) regarding related media content listing 540.

As indicated by the progression of credits 532 in media asset portion 530 of display 528 from the position of the credits 516 in media asset portion 514 of display 512, the credits 532 have continued to crawl while the viewer has scrolled related media content listings 538 and 540. In some embodiments, the media guidance application may pause the media asset displayed in media asset portion 530 (e.g., using DVR technology in a broadcast program), while the user browses related media content listings 538 and 540.

FIG. 5C shows illustrative media listing display 542 and display 558 that may be used to display related media content listings in accordance with some embodiments of the disclosure. Display 542 includes a media asset portion 544 and related media content listings portion 550. Related media content listings portion 550, now includes information about related media content listing 540 (FIG. 5B), which may have been selected by the user. Related media content listing profile 552 now includes information regarding related media content listing 540 (FIG. 5B) such as the title, description, preview image or clip, and a list of entities associated with related media content listing 540 (FIG. 5B). Related media content listings 556 lists an entity associated with related media content listing 540 (FIG. 5B). Related media content listing 556 has also been highlighted by the user. For example, a user may have instructed the media guidance application via control circuitry 304 (FIG. 3) to locate additional information regarding related media content listing 556.

Prompt 554 may allow a user to access, view, or purchase the content or additional information associated with related media content listing 540 (FIG. 5B). For example, selection of prompt 554 may replace media asset portion 544 with the media content associated with related media content listing 540 (FIG. 5B). In media asset portion 544, the crawl of credits 546 may be paused (e.g., via DVR technology). In some embodiments, credits 546 may continue to crawl. Entity 548, which may correspond to entity 534, is still selected.

Display 558 includes a media asset portion 560 and related media content listings portion 566. Related media content listings portion 566, now includes information about related media content listing 556, which may have been selected by the user in related media content listings portion 550. Related media content listing profile 572 now includes information regarding the entity associated with related media content listing 556, such as a preview image or clip, biographical information, and a list of entities associated with the entity associated with related media content listing 556. Related media content listings 568 and 570 list entities associated with the entity associated with related media content listing 556. In this manner, a viewer may browse information regarding cross-linked entities without having to return to a guide screen or exit the display of the credits. Related media content listing 570 has also been highlighted by the user. For example, a user may have instructed the media guidance application via control circuitry 304 (FIG. 3) to locate additional information regarding related media content listing 570. In media asset portion 544, the crawl of credits 546 may be paused (e.g., via DVR technology). In some embodiments, credits 546 may continue to crawl. Entity 548, which may correspond to entity 534, is still selected.

FIG. 6A is a flow-chart of illustrative steps involved for providing media content listings during the credits of a media asset in accordance with some embodiments of the disclosure. It should be noted that process 600 or any step thereof, could be displayed on, or provided by, any of the devices shown in FIGS. 3-4. For example, process 600 may be executed by control circuitry 304 (FIG. 3) as instructed by the media guidance application to display related media content listings on user equipment 402, 404, and/or 406 (FIG. 4) or any device accessible via communication network 414 (FIG. 4).

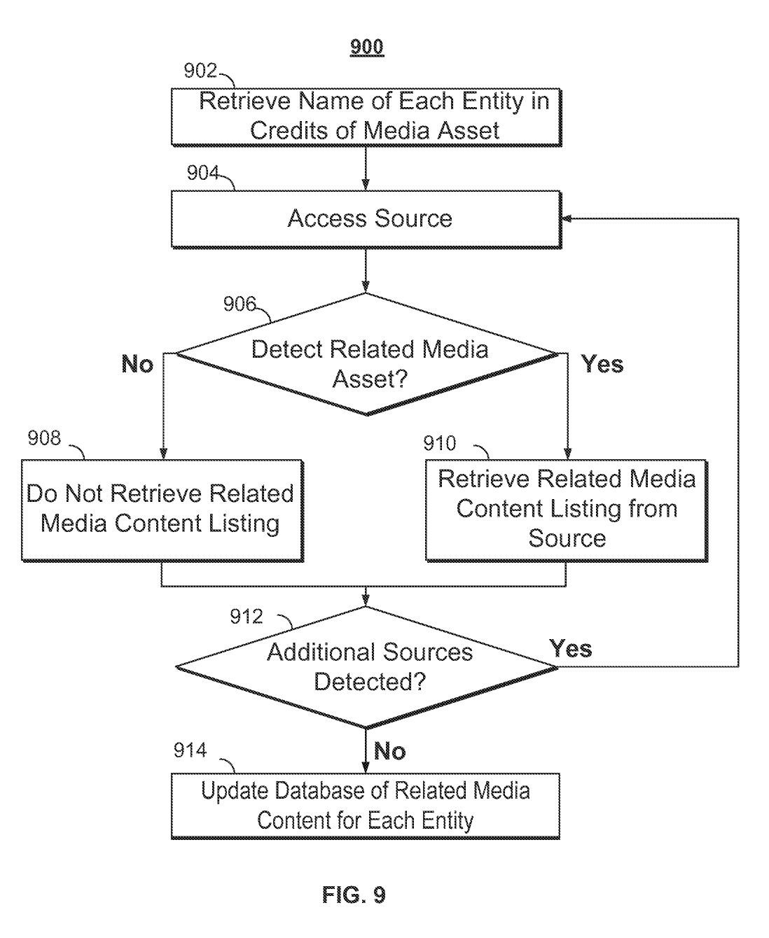

Process 600 may represent the process used to generate the related media content listings 524, 526, 538, and 540 (FIG. 5B). At step 602, process 600 compiles media content listings related to at least one of the entities in the credits of a media asset. In some embodiments, step 602 may incorporate one or more steps of process 900 (FIG. 9), as described below, to compile the related media content listings. In some embodiments, the media guidance application compiles the related media content listings (e.g., related media content listings 524, 526, 538 and 540 (FIG. 5B)) at media guidance source 418 (FIG. 4).

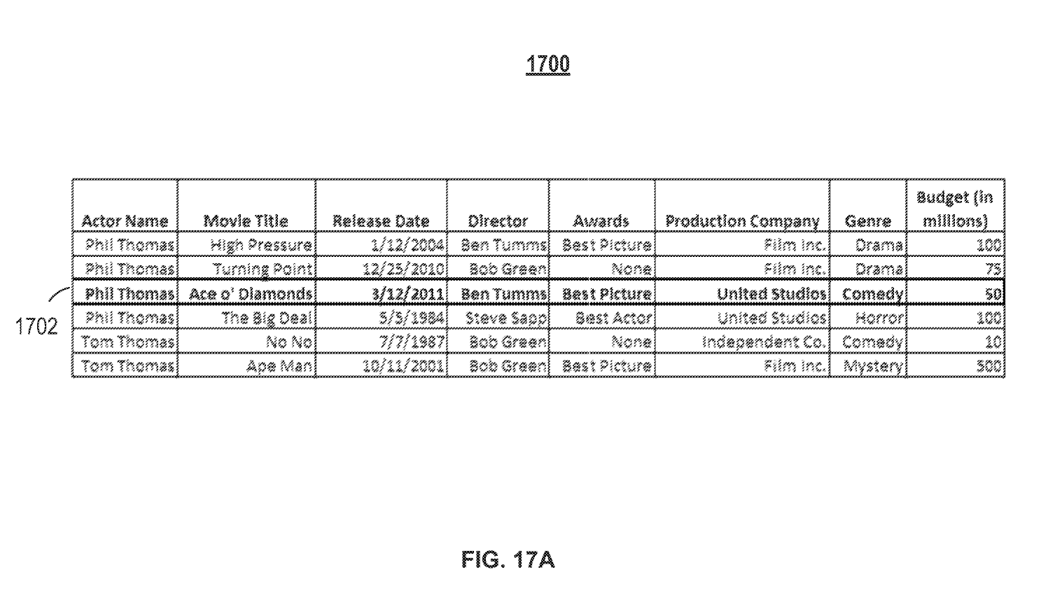

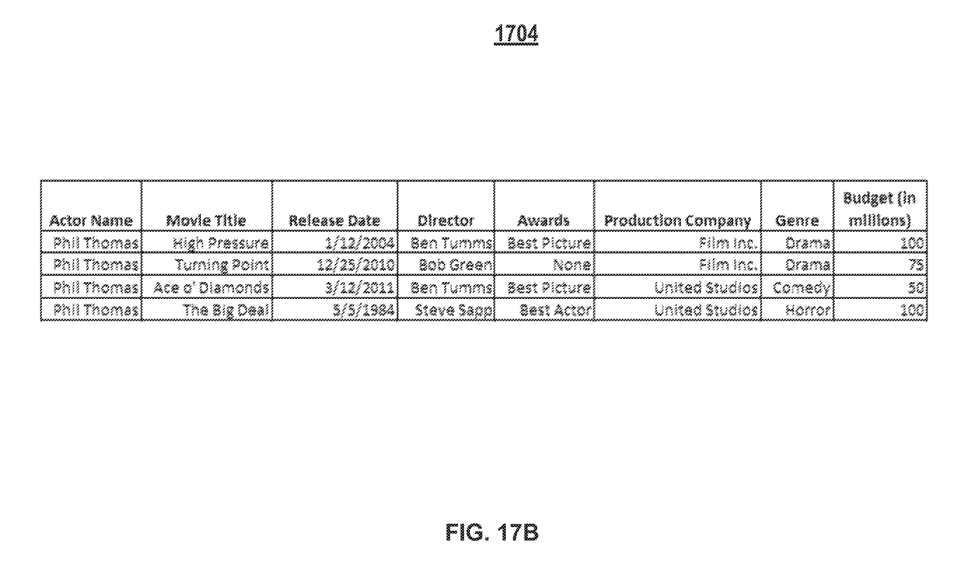

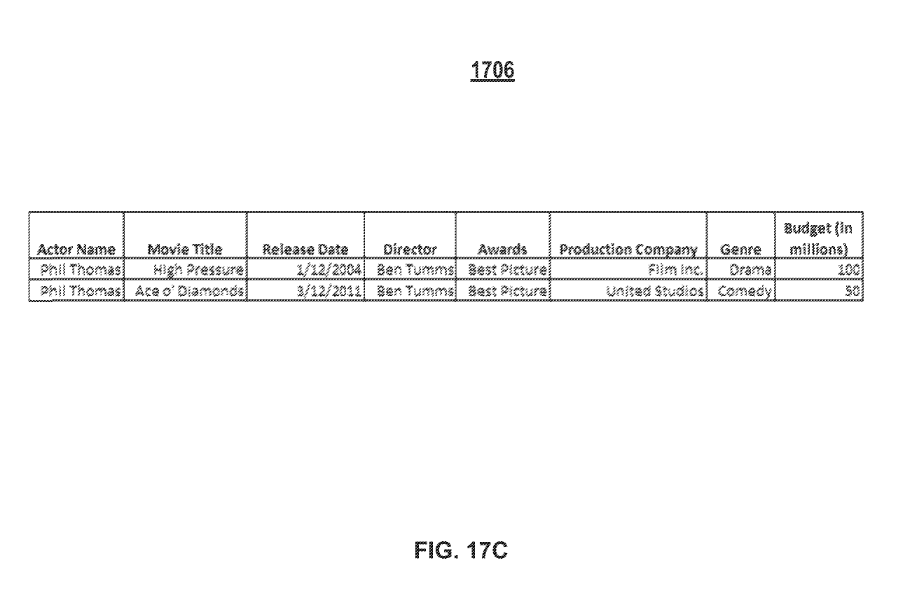

At step 604, process 600 stores the related media content listings. In some embodiments, the media guidance application may store the related media content listings (e.g., related media content listings 524, 526, 538 and 540 (FIG. 5B)) at the media guidance source 418 (FIG. 4), the content source 416 (FIG. 4), user equipment 402, 404, and/or 406 (FIG. 4) or any device accessible via communication network 414 (FIG. 4). In some embodiments, the related media content listings may be stored in a database incorporating various data structures (e.g., data structure 1700 (FIG. 17A)). For example, the data structure may incorporate a lookup table organized by the name or description of an entity (e.g., entity 518 (FIG. 5B)).

At step 606, process 600 displays the credits on a display screen. For example, process 600 may display the credits (e.g., credits 516 (FIG. 5B)) on a display screen (e.g., display 200 (FIG. 2), display 500 (FIG. 5A), display 506 (FIG. 5A), display 512 (FIG. 5B), display 528 (FIG. 5B)), 542 (FIG. 5C), and 558 (FIG. 5C), which may appear on user equipment 402, 404, and/or 406 (FIG. 4), or any device accessible via communication network 414 (FIG. 4). The display of the credits on the display screen may be executed by control circuitry 304 (FIG. 3) as instructed by the media guidance application.

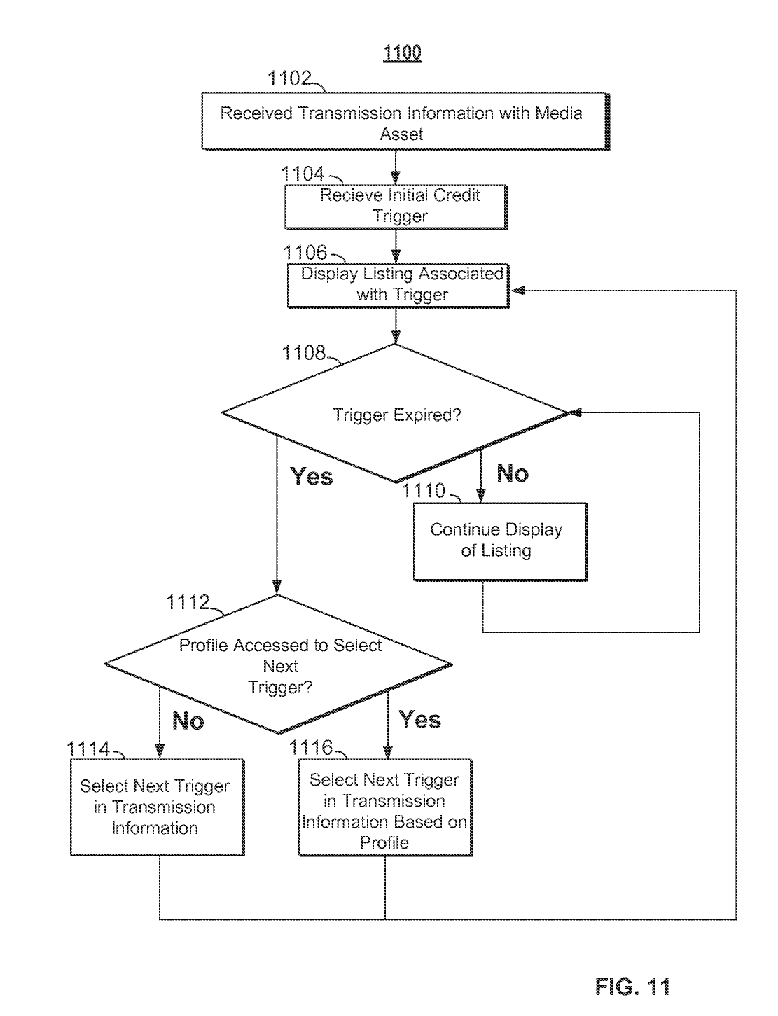

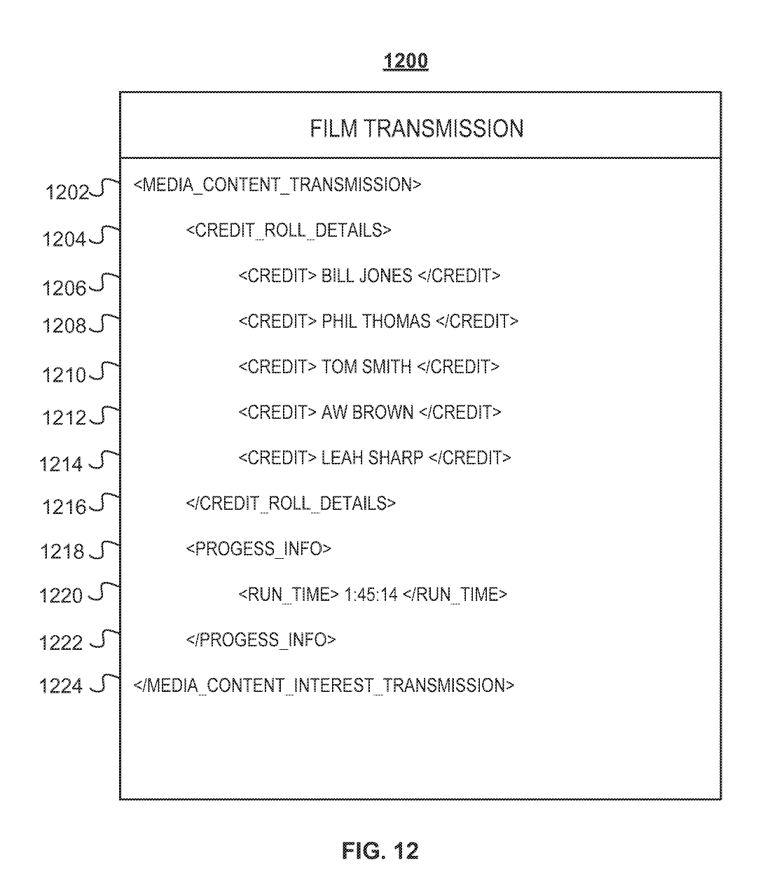

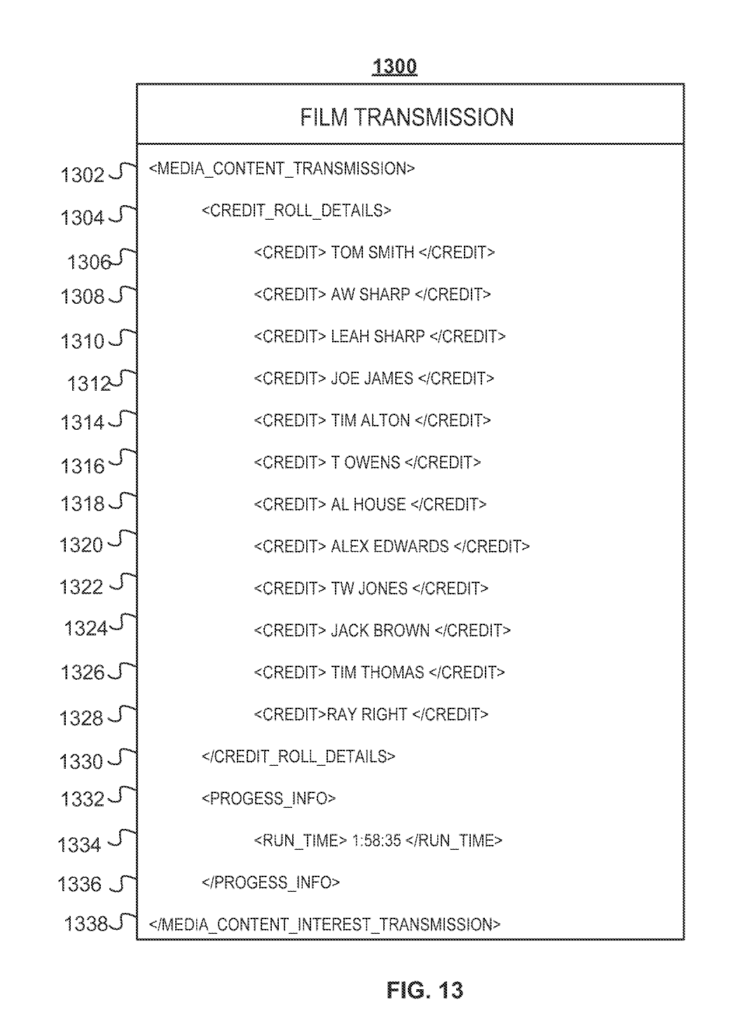

At step 608, process 600 receives a credit trigger associated with a display of an entity in the credits of the media asset on the display screen. In some embodiments, step 608 may incorporate one or more of the steps of process 1100 (FIG. 11). For example, the media guidance application may detect a credit trigger following the end of the featured presentation of a media asset (e.g., as discussed in reference to display 506 (FIG. 5A)). In some embodiments, the credit trigger may include tags related to data accompanying the media asset or other suitable methods of alerting the media guidance application to the presence of the credits as discussed in relation to process 1100 (FIG. 11). In some embodiments, the credit trigger may include lines of code as described in relation to FIGS. 12 and 13 below. In some embodiments, the credit trigger may indicate the appearance of credits in general (e.g., credits 516) in the display screen (e.g., display 512 (FIG. 5B)). In some embodiments, the credit trigger may indicate the appearance of the credit of a particular entity (e.g., entity 518 (FIG. 5B)). In some embodiments, credit trigger may be detected/received by control circuitry 304 (FIG. 3) of the media guidance application.

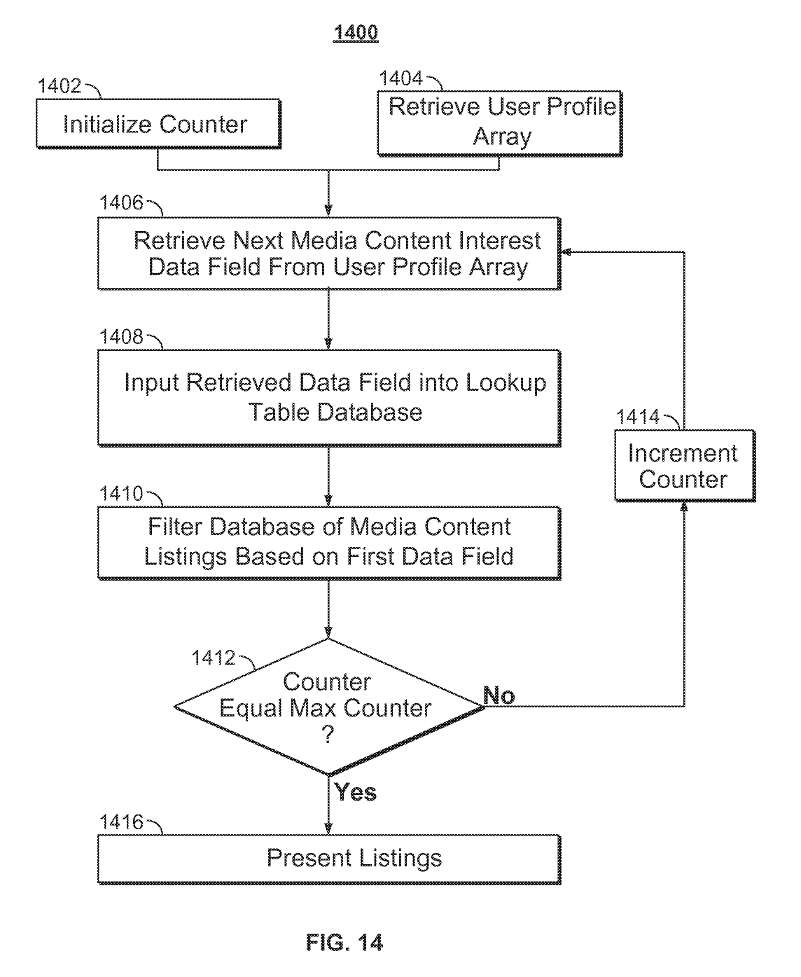

At step 610, in response to receiving the credit trigger, process 600 retrieves the related media content listings from the database. For example, the related media content listings may be retrieved from a database located at the media guidance source 418 (FIG. 4), the content source 416 (FIG. 4), user equipment 402, 404, and/or 406 (FIG. 4) or any device accessible via communication network 414 (FIG. 14). In some embodiments, the media guidance application may pre-fetch or pre-cache the related media content listings (e.g., related media content listings 524, 526, 538 and 540 (FIG. 5B)). For example, in response to determining a media asset is nearing a point (e.g., either the opening or ending of the media asset) likely to include credits, the media guidance application may transmit the related media content listings (e.g., related media content listings 524, 526, 538 and 540 (FIG. 5B)) and the associated links to user equipment 402, 404, and/or 406 (FIG. 4) or any device accessible via communication network 414 (FIG. 14). By transmitting the related media content listings and the associated links to the local equipment, the media guidance application may improve performance and reduce lag.

In some embodiments, the media guidance application may pre-fetch or pre-cache the related media content listings (e.g., related media content listings 524, 526, 538 and 540 (FIG. 5B)) relating to a specific entity (e.g., entity 518 (FIG. 5B)) upon detecting a credit trigger associated with the credits in general (e.g., credits 516 (FIG. 5B)). For example, the media guidance application may determine the entities associated with the media asset and may pre-cache the related media content listings (e.g., related media content listings 524, 526, 538 and 540 (FIG. 5B)) associated with each entity (e.g., entity 518 (FIG. 5B)) in expectation of displaying the related media content listings upon appearance of the particular entity appearing on the display screen (e.g., display 512 (FIG. 5B)). In some embodiments, the media guidance application may access the user profile (e.g., as described in relation to process 1100 (FIG. 11)) to determine which related media content listings should be pre-cached.

In some embodiments, related media content listings (e.g., related media content listings 524 and 526) may be supplemented or replaced by biographical information, textual information or other selectable content regarding an entity. For example, in some embodiments, related media content listings profiles may be displayed (e.g., related media content listing profiles 886 and 888 (FIG. 8C), which may or may not include related media content listings. The related media content listings profiles may provide biographical information about the entity.

At step 612, process 600 synchronizes the display of the related media content listings to the display of the entity as described below in relation to FIG. 7. For example, the media guidance application may coordinate the display the related media content listings (e.g., related media content listings 524, 526, 538 and 540 (FIG. 5B)) so that the related media content listings appear as the associated entity (e.g., entity 518 (FIG. 5B)) appears on the display screen (e.g., display 200 (FIG. 2), display 500 (FIG. 5A), display 506 (FIG. 5A), display 512 (FIG. 5B), display 528 (FIG. 5B)), 542 (FIG. 5C), and 558 (FIG. 5C), which may be displayed on user equipment 402, 404, and/or 406 (FIG. 4), or any device accessible via communication network 414 (FIG. 4).

In some embodiments, step 612 may incorporate one or more steps of process 1100 (FIG. 11). For example, step 612 may synchronize the display of the related media content listings to the display of the entity through the use of the credit triggers as described in relation to FIGS. 12 and 13. The control circuitry 304 (FIG. 3) may detect the presence of tags in lines of code (e.g., entity trigger 1208 (FIG. 12)) transmitted with media assets.

At step 614, process 600, without user input, presents the synchronized display of the related media content listings on the display screen simultaneously with at least a portion of the credits. For example, the media guidance application may display the related media content listings (e.g., related media content listings 524, 526, 538 and 540 (FIG. 5B)) as the associated entity (e.g., entity 518 (FIG. 5B)) appears on the display screen (e.g., display 200 (FIG. 2), display 500 (FIG. 5A), display 506 (FIG. 5A), display 512 (FIG. 5B), display 528 (FIG. 5B)), 542 (FIG. 5C), and 558 (FIG. 5C), which may appear on user equipment 402, 404, and/or 406 (FIG. 4), or any device accessible via communication network 414 (FIG. 4).

In some embodiments, the synchronized display may appear as a window (e.g., related media content listings portion 520 (FIG. 5B)). The media guidance application may account for the window in the display screen (e.g., display 512) by re-sizing the display of the credits (e.g., as shown in FIG. 8A), by appearing adjacent to, or around, the credits (e.g., as shown in FIG. 8B), by replacing the credits entirely (e.g., as shown in FIG. 8C), or by appearing in an overlay with varying transparency (e.g., as shown in FIG. 8D). In some embodiments, the media guidance application may use control circuitry 304 (FIG. 3) to execute the presentation of the display of the related media content listings on the display screen simultaneously with at least a portion of the credits.

In some embodiments, guide 220 (FIG. 2) may be used to establish settings for the media guidance application before or during the presentation of the media asset. For example, a user may adjust settings option 204 to display the related media content listings (e.g., related media content listings 524, 526, 538 and 540 (FIG. 5B)) for all media assets or selective media assets. For example, a user may configure the media guidance application to only display the related media content listings for a particular type of media asset (e.g., movies, television programs, videogames, or webcasts), for a particular time (e.g., eight o'clock on Friday nights), and/or when particular user are present (e.g., as indicated by intelligent detection systems detecting a user is within viewing distance).

It is contemplated that the steps or descriptions of FIG. 6A may be used with any other embodiment of this disclosure. In addition, the steps and descriptions described in relation to FIG. 6A may be done in alternative orders or in parallel to further the purposes of this disclosure. For example, each of these steps may be performed in any order or in parallel or substantially simultaneously to reduce lag or increase the speed of the system or method.

FIG. 6B is a flow-chart of illustrative steps involved for providing media content listings during the credits of a media asset in accordance with some embodiments of the disclosure. It should be noted that process 650 or any step thereof, could be displayed on, or provided by, any of the devices shown in FIGS. 3-4. For example, process 650 may be executed by control circuitry 304 (FIG. 3) as instructed by the media guidance application to display related media content listings on user equipment 402, 404, and/or 406 (FIG. 4) or any device accessible via communication network 414 (FIG. 4).

Process 650 may represent the process used to generate the related media content listings 524, 526, 538, and 540 (FIG. 5B). At step 652, process 650 compiles media content listings related to at least one of the entities in the credits of a media asset. In some embodiments, step 652 may incorporate one or more steps of process 900 (FIG. 9), as described below, to compile the related media content listings. In some embodiments, the media guidance application compiles the related media content listings (e.g., related media content listings 524, 526, 538 and 540 (FIG. 5B)) at media guidance source 418 (FIG. 4). In some embodiments, process 650 may also compile mappings of the location of entities in the media asset.

At step 654, process 650 stores the related media content listings. In some embodiments, the media guidance application may store the related media content listings (e.g., related media content listings 524, 526, 538 and 540 (FIG. 5B)) at the media guidance source 418 (FIG. 4), the content source 416 (FIG. 4), user equipment 402, 404, and/or 406 (FIG. 4) or any device accessible via communication network 414 (FIG. 4). In some embodiments, the related media content listings may be stored in a database incorporating various data structures (e.g., data structure 1700 (FIG. 17A)). For example, the data structure may incorporate a lookup table organized by the name or description of an entity (e.g., entity 518 (FIG. 5B)).

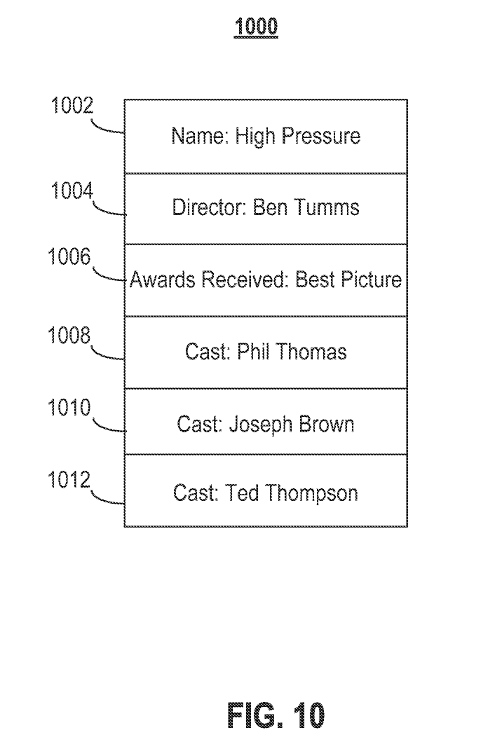

At step 656, process 650 receives a mapping of the location the entities in the credits of the media asset on the display screen. For example, the media guidance application may determine that a particular entity will be displayed following the end of the featured presentation of a media asset (e.g., as discussed in reference to array 1000 (FIG. 10)). In some embodiments, the mapping may include the name and location. For example, the mapping may describe the particular run-time of the media asset at which the entity will be shown. In some embodiments, the mapping may include lines of code as described in relation to FIGS. 12 and 13 below. For example, in some embodiments, the mapping may include run-time information (e.g., run-time information 1220 (FIG. 12)). The run-time information may determine the particular time, frame, etc. of the media asset at which the entity may be shown in the display screen (e.g., display 512 (FIG. 5B)). In some embodiments, the names and locations of all entities appearing in the media asset may be included in data structures associated with the media asset (e.g., array 1000 (FIG. 10)).

At step 658, in response to processing the mapping, process 650 retrieves the related media content listings from the database. For example, the related media content listings may be retrieved from a database located at the media guidance source 418 (FIG. 4), the content source 416 (FIG. 4), user equipment 402, 404, and/or 406 (FIG. 4) or any device accessible via communication network 414 (FIG. 14). In some embodiments, the media guidance application may pre-fetch or pre-cache the related media content listings (e.g., related media content listings 524, 526, 538 and 540 (FIG. 5B)). For example, in response to determining a media asset is nearing a point (e.g., either the opening or ending of the media asset) likely to include credits as indicated by the mapping, the media guidance application may transmit the related media content listings (e.g., related media content listings 524, 526, 538 and 540 (FIG. 5B)) and the associated links to user equipment 402, 404, and/or 406 (FIG. 4) or any device accessible via communication network 414 (FIG. 14). By transmitting the related media content listings and the associated links to the local equipment, the media guidance application may improve performance and reduce lag.

In some embodiments, the media guidance application may pre-fetch or pre-cache the related media content listings (e.g., related media content listings 524, 526, 538 and 540 (FIG. 5B)) relating to a specific entity (e.g., entity 518 (FIG. 5B)) upon detecting an entity as determined by the mapping. For example, the media guidance application may determine the entities associated with the media asset and may pre-cache the related media content listings (e.g., related media content listings 524, 526, 538 and 540 (FIG. 5B)) associated with each entity (e.g., entity 518 (FIG. 5B)) in expectation of displaying the related media content listings upon appearance of the particular entity appearing on the display screen (e.g., display 512 (FIG. 5B)). In some embodiments, the media guidance application may access the user profile (e.g., as described in relation to process 1100 (FIG. 11)) to determine which related media content listings should be pre-cached.

In some embodiments, related media content listings (e.g., related media content listings 524 and 526) may be supplemented or replaced by biographical information, textual information or other selectable content regarding an entity. For example, in some embodiments, related media content listings profiles may be displayed (e.g., related media content listing profiles 886 and 888 (FIG. 8C), which may or may not include related media content listings. The related media content listings profiles may provide biographical information about the entity.

At step 660, process 650 synchronizes the display of the related media content listings to the display of the entity as described below in relation to FIG. 7. For example, the media guidance application may coordinate the display the related media content listings (e.g., related media content listings 524, 526, 538 and 540 (FIG. 5B)) so that the related media content listings appear as the associated entity (e.g., entity 518 (FIG. 5B)) appears on the display screen (e.g., display 200 (FIG. 2), display 500 (FIG. 5A), display 506 (FIG. 5A), display 512 (FIG. 5B), display 528 (FIG. 5B)), 542 (FIG. 5C), and 558 (FIG. 5C), which may be displayed on user equipment 402, 404, and/or 406 (FIG. 4), or any device accessible via communication network 414 (FIG. 4).

At step 652, process 650, without user input, presents the synchronized display of the related media content listings on the display screen simultaneously with at least a portion of the credits. For example, the media guidance application may display the related media content listings (e.g., related media content listings 524, 526, 538 and 540 (FIG. 5B)) as the associated entity (e.g., entity 518 (FIG. 5B)) appears on the display screen (e.g., display 200 (FIG. 2), display 500 (FIG. 5A), display 506 (FIG. 5A), display 512 (FIG. 5B), display 528 (FIG. 5B)), 542 (FIG. 5C), and 558 (FIG. 5C), which may appear on user equipment 402, 404, and/or 406 (FIG. 4), or any device accessible via communication network 414 (FIG. 4).

In some embodiments, the synchronized display may appear as a window (e.g., related media content listings portion 520 (FIG. 5B)). The media guidance application may account for the window in the display screen (e.g., display 512) by re-sizing the display of the credits (e.g., as shown in FIG. 8A), by appearing adjacent to, or around, the credits (e.g., as shown in FIG. 8B), by replacing the credits entirely (e.g., as shown in FIG. 8C), or by appearing in an overlay with varying transparency (e.g., as shown in FIG. 8D). In some embodiments, the media guidance application may use control circuitry 304 (FIG. 3) to execute the presentation of the display of the related media content listings on the display screen simultaneously with at least a portion of the credits.

In some embodiments, guide 220 (FIG. 2) may be used to establish settings for the media guidance application before or during the presentation of the media asset. For example, a user may adjust settings option 204 to display the related media content listings (e.g., related media content listings 524, 526, 538 and 540 (FIG. 5B)) for all media assets or selective media assets. For example, a user may configure the media guidance application to only display the related media content listings for a particular type of media asset (e.g., movies, television programs, videogames, or webcasts), for a particular time (e.g., eight o'clock on Friday nights), and/or when particular user are present (e.g., as indicated by intelligent detection systems detecting a user is within viewing distance).

It is contemplated that the steps or descriptions of FIG. 6B may be used with any other embodiment of this disclosure. In addition, the steps and descriptions described in relation to FIG. 6B may be done in alternative orders or in parallel to further the purposes of this disclosure. For example, each of these steps may be performed in any order or in parallel or substantially simultaneously to reduce lag or increase the speed of the system or method.

FIG. 7 shows illustrative media listing display 700 and display 750 that may be used to display (e.g., on user equipment 402, 404, and/or 406 (FIG. 4), or any device accessible via communication network 414 (FIG. 4)) related media content listings in accordance with some embodiments of the disclosure. FIG. 7 further shows the synchronization of a display of the related media content listings to the display of the entity as described in step 612 (FIG. 6A) and/or step 660 (FIG. 6B). Display 700 includes media asset portion 704, which currently displays credits 706. In response to the appearance of credits 706, the media guidance application generates related media content listings portion 710. Related media content listings portion 710 currently displays related media content listings 714 and 716 in related media content listings profile 712, which correspond to “Phil Thomas,” the entity 708 highlighted in credits 706.

In media asset portion 704, credits 706 have crawled from the bottom of media asset portion 704 to the top of media asset portion 704. Entity 708 now appears closer to the top of the media asset portion 704. In some embodiments, display 750 may represent a further time progression of display 700 as the media asset shown in media asset portion 704 has continued to play and is now further progressed.

Display 750 includes media asset portion 754, which includes credits 756 and entity 758. Entity 758 is different than entity 708. Related media content listings portion 760 includes related media content listings profile 762, which relates to entity 758, “Al House,” related media content listing 764, and related media content listings 766. In some embodiments, related media content listing 538 may correspond to related media content listing 526. Entity 708 is no longer displayed in credits 756 as shown in the media asset portion 754 of display 750. For example, as the credits have crawled up the display, entity 708 has been crawled off-screen.

In some embodiments, at the direction of the media guidance application, the control circuitry 304 (FIG. 3) may automatically change the related media content listings (e.g., replaced related media content listings 714 and 716 with related media content listings 764 and 766) due to entity 708 being crawled off-screen. In some embodiments, the media guidance application may change the related media content listings after a certain amount of time (e.g., ten seconds), or in response to a user input (e.g., an input directing the media guidance application to display related media content listings for another entity), or due to the selection, or lack thereof, of a related media content listings (e.g., selection of related media content listings 714 and 716).

For example, the media guidance application may display the related media content profile (e.g., related media content profile 712) for a specific amount of time. If the user does not select a related media content listing (e.g., related media content listings 714 and 716), the media guidance application presents another related media content profile (e.g., related media content listings profile 762). In some embodiments, the media guidance application may pause the media asset displayed in media asset portion 704 (e.g., using DVR technology in a broadcast program), while the user browses related media content profile 712.

In some embodiments, FIG. 7 may display the results of the media guidance application receiving credit triggers as discussed below in process 1100 (FIG. 11). For example, the change from related media content listings profile 712 to related media content listings profile 762 may result from detection, by the media guidance application, of credit triggers as described in relation to FIGS. 12 and 13. The control circuitry 304 (FIG. 3) may detect the presence of tags in lines of code (e.g., entity trigger 1208 (FIG. 12)) transmitted with media assets and indicate to the media guidance application that the related media content listings profile (e.g., related media content listings profile 712) should be changed.

FIGS. 8A-D show variations of the display of related media content listings and scrolling operations, which may be executed by the media guidance application (e.g., through control circuitry 304 (FIG. 3)). For example, in order to display the related media content listings, the media guidance application may re-size the media asset portion (e.g., as shown in FIG. 8A), may position the related media content listings adjacent to, above, or around, the credits (e.g., as shown in FIG. 8B), may replace the credits entirely with related media content listings (e.g., as shown in FIG. 8C), or may display the related media content listings in an overlay with varying degrees of transparency (e.g., as shown in FIG. 8D).

FIG. 8A shows illustrative media listing display 800 and display 820 that may be used to display related media content listings in accordance with some embodiments of the disclosure. Display 800 includes media asset portion 804, which currently displays credits 806. In response to the appearance of credits 806, the media guidance application generates related media content listings portion 810. Related media content listings portion 810 currently displays related media content listings 814, 816 and 818 in related media content listings profile 810, which correspond to “Phil Thomas,” the entity 808 highlighted in credits 806.

Display 820 includes a media asset portion 824. In media asset portion 824, credits 826 have crawled up media asset portion 824. Related media content listing portion 830 includes related media content listing 836, 838, and 834. In some embodiments, related media content listing 836 corresponds to related media content listing 816, related media content listing 838 corresponds to related media content listing 818, and related media content listing 834 corresponds to related media content listing 814. In display 820, a user has performed a scroll operation (e.g., via user input 310 (FIG. 3)) upon related media content listing 836, 838, and 834. As shown in display 820, related media content listing 814 of display 800, which corresponds to related media content listing 834 has been moved to a less prominently position (e.g., the back of the related media content listings), whereas related media content listings 836, which corresponds to related media content listings 816 of display 800, has been moved to a more prominent position (e.g., the front of the related media content listings).

Display 820 also shows prompt 840. In some embodiments, prompt 840 may direct a user to additional content. For example, upon selection of prompt 840 by a user (e.g., via user input 310 (FIG. 3)), the media guidance application may instruct control circuitry 304 (FIG. 3)) to display related media content listings for other entities credits 826, additional related media content listings for the selected entity (e.g., entity 828), additional content as determined by a user profile (e.g., similar actors, actresses, etc. to the selected entity), and/or additional content regarding the related media content listings (e.g., trailers, bloopers, video clips, web-content, extra features, bios, summaries, movie or series information, recommendations, and/or critical reviews).

FIG. 8B shows illustrative media listing display 842 and display 856 that may be used to display related media content listings in accordance with some embodiments of the disclosure. Display 842 includes media asset portion 844, which currently displays credits 852. In response to the appearance of credits 852, the media guidance application generates related media content listings 846, 848 and 850. Related media content listings 846, 848 and 850 correspond to entity 854 in credits 852.

Display 856 includes a media asset portion 858. In media asset portion 858, credits 866 have crawled up media asset portion 858. Related media content listing 860, related media content listing 862, and prompt 864 have adjusted their position and size in order to not obscure the credits 866. In some embodiments, related media content listing 860 corresponds to related media content listing 848 and related media content listing 862 corresponds to related media content listing 850. In display 856, a user has performed a scroll operation (e.g., via user input 310 (FIG. 3)) upon related media content listing 860, related media content listing 862, and prompt 864.

As shown in display 856, related media content listing 846 of display 842 has been moved off-screen (e.g., the back of the related media content listings), whereas related media content listings 860, which corresponds to related media content listings 848 has been moved up, and prompt 864 is now displayed.

FIG. 8C shows illustrative media listing display 870 and display 882 that may be used to display related media content listings in accordance with some embodiments of the disclosure. In display 870, the media asset portion has been entirely replaced with the related media content listing portion 872 by the media guidance application. In response to the detecting the presence of credits, the media guidance application replaced the credits with related media content listings 876, 878 and 880, which relate to entity prompt 854. In display 882, the media asset portion has been entirely replaced with the related media content listing portion 884 by the media guidance application. Related media content listing portion 884 includes related media content listings profile 886 and related media content listings profile 888, which each correspond to different entities.

In some embodiments, the lack of the display of credits or a media asset portion on display 882 does not affect the time the related media content listings profile 886 and related media content listings profile 888 are shown. For example, the media guidance application may continue to synchronize the display of related media content with the display of the entities in the credits, even though the entities are not shown on the display 882. For example, if the crawl of the credits would result in a particular entity appearing on the display 882 in the case where the media asset portion was not obscured, the related media content listings for that entity are shown in the related media content listing portion 884 of display 882.

FIG. 8D shows illustrative media listing display 890 that may be used to display related media content listings in accordance with some embodiments of the disclosure. In display 890, the media asset portion 892 is displaying credits 894. In response to detecting the presence of credits, the media guidance application presents related media content listing 896 and related media content listing 898. As shown by display 890, related media content listing 896 and related media content listing 898 have varying degrees of transparency. In some embodiments, as the related media content listings are scrolled through (e.g., via user input 312 (FIG. 3), the transparency of the related media content may change. For example, related media content listings displayed more prominently (e.g., in front of other related media content listings) such as related media content listings 896 is less transparent than related media content listings displayed less prominently (e.g., behind other related media content listings) such as related media content listings 898.

FIG. 9 is a flow-chart of illustrative steps involved in compiling related media content listings for display during the credits of a media asset in accordance with some embodiments of the disclosure. It should be noted that process 900 or any step thereof, could be displayed on, or provided by, any of the devices shown in FIGS. 3-4. For example, process 900 may be executed by a server at the media guidance source 418 (FIG. 4) as instructed by the media guidance application.

Process 900 describes a process used to accumulate information on a database regarding credit information used to compile media content listings related to entities in the credits of a media asset as described in step 602 (FIG. 6A) and/or step 652 (FIG. 6B). For example, in order to display related media content listings in step 614 (FIG. 6A) and/or step 654 (FIG. 6B), the media guidance application must first determine the related media content listings that are associated with each entity in a media asset.

At step 902, process 900 retrieves the name of each entity in the credits of a media asset. The media guidance application may extract that information and arrange it into an array associated with the media asset (e.g., array 1000 (FIG. 10). Process 900 then begins a process of determining other media assets that are related to the names in the array.

At step 904, the media guidance application accesses a source. The source may include content source 416 (FIG. 4), media guidance source 418 (FIG. 4), or any other device accessible via the communication network 414 (FIG. 4). In some embodiments, the source may be a database or other collection of information located either locally or remotely. For example, a source may be located from a website on the Internet. In some embodiments, the source may be a repository of credit information about various media assets (e.g., a web-site which provides details about the production, including the cast and crew, of media assets).

At step 906, process 900 determines whether or not there are media assets featuring the same entity as one of the entities from the credits of the media asset. To determine whether or not an entity's name is present in the source, the media guidance application may use any of the types of object recognition discussed above. For example, process 900 may process each name of each entity in the credits of every media asset located at the source using fuzzy logic (e.g., to detect alternative spellings) and using quality control measures (e.g., verifying the identity of the entity to ensure there are not multiple entities using the same name). In some embodiments, process 900 may be executed by a server at the media guidance source 418 (FIG. 4) as instructed by the media guidance application.

If the media guidance application does not detect related media assets for the entity in the credits of the media asset, the media guidance application does not retrieve related media content listings from the source at step 908. If the media guidance application does detect related media assets for the entity in the credits of the media asset, the media guidance application retrieves related media content listings from the source at step 910. In some embodiments, the media guidance application may instruct the media guidance application to store the retrieved related media content listing on temporary storage at the media guidance source 418 (FIG. 4).

At step 912, process 900 may detect additional sources. For example, the media guidance application may instruct a server at media guidance source 418 (FIG. 4) to process or scan the information on one or more sources. The sources may be particular sources or all sources available (e.g., via communication network 414 (FIG. 4)). At step 914, the media guidance application may update a database located at, or remotely to, media guidance source 418 (FIG. 4) with the related media content listings for each entity in the credits of a particular media asset.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

FIG. 10 shows an exemplary data structure for a compilation of data associated with an entity in a media asset in accordance with some embodiments of the disclosure. For example, the data structure shown in FIG. 10 may represent the information processed or scanned in step 902 (FIG. 9) of process 900 (FIG. 9). In some embodiments, each media asset may have a corresponding data structure (e.g., array 1000) which describes the media asset and the entities in the credits.

FIG. 10 shows array 1000. In some embodiments, array 1000 is associated with a particular media asset (e.g., a movie). Array 1000 contains data field 1002. Data field 1002 indicates the name of the media asset is “High Pressure.” Data field 1002 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets featuring the actor “Phil Thomas.” Upon locating “Phil Thomas” in an array (e.g., array 1000), the media guidance application may use the other data fields in the array (e.g., a data field corresponding to the title of the media asset) to construct a related media content listing (e.g., related media content listings 814 and 816 (FIG. 8A). The related media content listing may then be displayed during the credits of a media asset featuring “Phil Thomas” (e.g., display 800 (FIG. 8A)).

Array 1000 also contains data field 1004. Data field 1004 indicates the name of the director of the media asset is “Ben Tumms.” Data field 1004 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets directed by “Ben Tumms.” Upon locating “Ben Tumms” in an array (e.g., array 1000), the media guidance application may use the other data fields in the array (e.g., a data field corresponding the title of the media asset) to construct a related media content listing (e.g., related media content listings 814 and 816 (FIG. 8A). The related media content listing may then be displayed during the credits of a media asset directed by “Ben Tumms” (e.g., display 800 (FIG. 8A)).

Array 1000 also contains data field 1006. Data field 1006 indicates the media asset was awarded “Best Picture.” Data field 1006 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets awarded “Best Picture.” Upon locating “Best Picture” in a data field corresponding to awards received by the media asset, the media guidance application may use the other data fields in the array (e.g., a data field corresponding the title of the media asset) to construct a related media content listing (e.g., related media content listings 814 and 816 (FIG. 8A).

Array 1000 also contains data fields 1008, 1010, and 1012. Data field 1008, 1010, and 1012 indicate the media asset features actors “Phil Thomas,” “Joseph Brown,” and “Ted Thompson.” Data fields 1008, 1010, and 1012 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets featuring actors “Phil Thomas,” “Joseph Brown,” and “Ted Thompson.” Upon locating a media asset featuring one of these actors, the media guidance application may use the other data fields in the array (e.g., a data field corresponding the title of the media asset) to construct a related media content listing (e.g., related media content listings 814 and 816 (FIG. 8A). The related media content listing may then be displayed during the credits of a media asset featuring actors “Phil Thomas,” “Joseph Brown,” and/or “Ted Thompson.” (e.g., display 800 (FIG. 8A)).

It should be noted that the information presented in array 1000 is illustrative and is not meant to be limiting as to the amount or type of information that may be stored by the media guidance application.

FIG. 11 is a flow-chart of illustrative steps involved for receiving a credit trigger and displaying related media content listings during the credits of a media asset in accordance with some embodiments of the disclosure. It should be noted that process 1100 or any step thereof, could be displayed on, or provided by, any of the devices shown in FIGS. 3-4. For example, process 1100 may be executed by control circuitry 304 as instructed by the media guidance application.

At step 1102, process 1100 processes the received transmission information of the media asset. In some embodiments, the media guidance application may process transmission information (e.g., data structure 1200 (FIG. 12) and data structure 1300 (FIG. 13)) accompanying the media asset. In some embodiments, the transmission information may be metadata transmitted with the media asset.

At step 1104, process 1100 may retrieve an initial credit trigger. The credit trigger may indicate to the media guidance application that the media asset is displaying credits (e.g., opening trigger 1204 (FIG. 12)) or may indicate the display of a particular entity (e.g., entity trigger 1206 (FIG. 12)). In some embodiments, process 1100 may retrieve run-time information (e.g., run-time information 1220 (FIG. 12)), which indicates to the media guidance application the point of progress of the media asset. The media guidance application may cross-reference (e.g., via a lookup table) the run-time at which the credits for the media asset begin to play. The media guidance application may then display the related media content listings at that particular time.

In some embodiments, the credit trigger may be a change in audio or visual aspects of the media asset. For example, the media guidance application may determine that the background of the media asset has gone black and/or a large amount of text is beginning to be shown, which is typical of end credits. In some embodiments, the media guidance application may detect particular sounds, tones, or music, which accompanies the display of credits, in the media asset.

At step 1106, in response to receiving a credit trigger, process 1100 displays a related media content listing associated with the trigger (e.g., related media content listings 524 and 526 (FIG. 5B)) in a display (e.g., display 512 (FIG. 5B)). The listing may be displayed in any of the embodiments shown in FIGS. 8A-8D.

At step 1108, process 1100 determines whether or not the trigger has expired. In some embodiments, the trigger may expire after a predetermined period of time. In some embodiments, the trigger may expire if a user scrolls, but does not select, the related media content listings. In some embodiments, the trigger may expire when the entity associated with the trigger scrolls off-screen (e.g., as described in relation to FIG. 7). In some embodiments, the trigger may expire if it no longer appears on the transmission information. For example, data structure 1200 (FIG. 12), which includes entity trigger 1206 (FIG. 12), may be replaced with data structure 1300 (FIG. 13)), which does not include the entity trigger 1206 (FIG. 12). This may cause the trigger to expire.

If the trigger is not expired, process 1100 continues to display the related media content listings on the display at step 1110. Process 1100 then returns to step 1108. In some embodiments, process 1100 may determine whether or not the trigger has expired in real-time or periodically. For example, in some embodiments, the media guidance application may receive a constant data feed of transmission information.

If the trigger is expired, process 1100 continues to step 1112. At step 1112, process 1100 determines if profile information is accessed to select the next trigger. If so, process 1100 continues to step 1114. If not, process 1100 continues to step 1116. For example, in some embodiments, the media guidance application may determine particular entities for which to display related media content listings based on a user profile as discussed in relation to FIG. 14.

After selecting the next trigger in the transmission information, process 1100 returns to step 1106. For example, in some embodiments, process 1100 may describe FIG. 7. The initial trigger (e.g., entity trigger 1208 (FIG. 12)) for a first entity (e.g., entity 708 (FIG. 7)) may have expired, and the media guidance application may have selected the next trigger (e.g., entity trigger 1318 (FIG. 13)) associated with a second entity (e.g., entity 758 (FIG. 7)) as the next entity to have related media content listings (e.g., related media content listings 764 and 766 (FIG. 7) shown on a display (e.g., display 750).

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method.

FIGS. 12 and 13 show exemplary data structures for transmission information associated with a media asset in accordance with some embodiments of the disclosure. In some embodiments, FIGS. 12 and 13 may represent transmission information for the same media asset, and FIG. 12 may represent transmission information, which precedes FIG. 13.

For example, as indicated by run-time information 1220 (FIG. 12) and run-time information 1334 (FIG. 13), data structure 1200 (FIG. 12) may precede data structure 1300 (FIG. 13)) by several minutes. FIGS. 12 and 13 may be transmitted to the media guidance application by content source 416 (FIG. 4), media guidance source 418 (FIG. 4), or any other source accessible via the communication network 414 (FIG. 4). Data structure 1200 (FIG. 12) and data structure 1300 (FIG. 13)) may be transmitted to the media guidance application in metadata accompanying the media asset. In some embodiments, data structure 1200 (FIG. 12) and data structure 1300 (FIG. 13)) may be received by control circuitry 304 to provide information to the media guidance application. It should be noted that the information presented in FIGS. 12 and 13 is illustrative and is not meant to be limiting as to the amount or type of information that may be transmitted in transmission information.

FIG. 12 shows an exemplary data structure for a data transmission associated with a media asset in accordance with some embodiments of the disclosure. FIG. 12 shows data structure 1200. In some embodiments, data structure 1200 may correspond to display 700 (FIG. 7)). Data structure 1200 contains line 1202, which indicates to the media guidance application the beginning of data structure 1200, a media content transmission file. Opening trigger 1204 indicates that credits (e.g., credits 516 (FIG. 5A) are displayed on the media asset portion (e.g., media asset portion 514) of the display (e.g., display 512). Entity triggers 1206, 1208, 1210, 1212, and 1214 indicate to the media guidance application that particular entities are being displayed on the display.

In some embodiments, entity triggers 1206, 1208, 1210, 1212, and 1214 may be used to synchronize the display of related media content (e.g., related media content listings 524 and 526 (FIG. 5B)) in a display (e.g., display 512 (FIG. 5B) as described in step 612 of FIG. 6A. For example, in some embodiments, process 600 (FIG. 6A) may synchronize the display of the related media content listings to the display of the entity based on the presence of entity triggers (e.g., entity triggers 1206, 1208, 1210, 1212, and 1214) in transmission information (e.g., data structure 1200).

Closing trigger 1214 may indicate the end of the entity triggers listed on the display. Progress information trigger 1218 indicates to the media guidance application the presence of progress information. For example, in some embodiments, process 600 (FIG. 6A) and/or process 650 (FIG. 6B) may synchronize the display of the related media content listings to the display of the entity based on the progress of the media asset. The progress of the media asset may be determined by progress information. For example, in some embodiments, process 1100 (FIG. 11) may retrieve run-time information (e.g., run-time information 1220 (FIG. 12)), which indicates to the media guidance application the point of progress of the media asset (e.g., one hour, forty-five minutes, and fourteen seconds). The media guidance application may cross-reference (e.g., via a lookup table) the particular run-time at which an entity appears in the credits of a media asset. The media guidance application may then display the related media content listings at that particular time. Progress information trigger 1218 indicates the end of the progress information to the media guidance application, and line 1224 indicates the end of the transmission information file.

FIG. 13 shows an exemplary data structure for a data transmission associated with a media asset in accordance with some embodiments of the disclosure. FIG. 13 shows data structure 1300. In some embodiments, data structure 1300 may correspond to display 750 (FIG. 7)). Data structure 1300 contains line 1302, which indicates to the media guidance application the beginning of data structure 1300, a media content transmission file. Opening trigger 1304 indicates that credits (e.g., credits 516 (FIG. 5A) are displayed on the media asset portion (e.g., media asset portion 514) of the display (e.g., display 512). Entity triggers 1306, 1308, 1310, 1312, 1314, 1316, 1318, 1320, 1322, 1324, 1326, and 1328 indicate to the media guidance application that particular entities are being displayed on the display.

In some embodiments, entity triggers 1306, 1308, 1310, 1312, 1314, 1316, 1318, 1320, 1322, 1324, 1326, and 1328 may be used to synchronize the display of related media content (e.g., related media content listings 524 and 526 (FIG. 5B)) in a display (e.g., display 512 (FIG. 5B) as described in step 612 of FIG. 6A. For example, in some embodiments, process 600 (FIG. 6A) may synchronize the display of the related media content listings to the display of the entity based on the presence of entity triggers (e.g., entity triggers 1306, 1308, 1310, 1312, 1314, 1316, 1318, 1320, 1322, 1324, 1326, and 1328) in transmission information (e.g., data structure 1300).

In some embodiments, entity triggers 1306, 1308, 1310, 1312, 1314, 1316, 1318, 1320, 1322, 1324, 1326, and 1328 represent the entities currently displayed in a media asset portion (e.g., media asset portion 704 (FIG. 7) of a display (e.g., display 700). For example, in some embodiments, the difference between the entities listed in data structure 1200 (FIG. 12) and data structure 1300 may correspond to the names of entities that have either crawled on-screen or crawl off-screen between the receipt of data structure 1200 (FIG. 12) and data structure 1300.

Closing trigger 1330 may indicate the end of the entity triggers listed on the display. Progress information trigger 1332 indicates to the media guidance application the presence of progress information. Run-time information 1334 indicates to the media guidance application the point of progress of the media asset is one-hour, fifty-eight minutes, and thirty-five seconds. Progress information trigger 1336 indicates the end of the progress information to the media guidance application, and line 1338 indicates the end of the transmission information file.

FIG. 14 is a flow-chart of illustrative steps involved for displaying related media content listings during the credits of a media asset according to a user profile in accordance with some embodiments of the disclosure. In some embodiments, FIG. 14 may be a more detailed description of the process of step 1112 (FIG. 11). For example, process 1400 may describe the method used to select the next trigger based on a profile. It should be noted that process 1400 or any step thereof, could be displayed on, or provided by, any of the devices shown in FIGS. 3-4. For example, process 1400 may be executed by control circuitry 304 as instructed by the media guidance application.

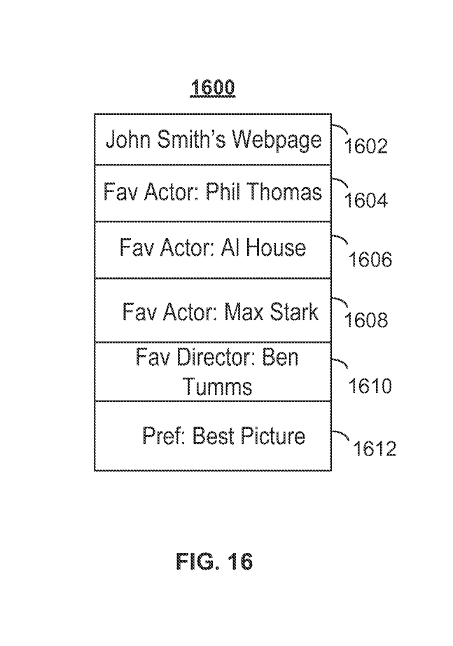

FIG. 14 shows process 1400. At step 1402, process 1400 initializes a counter. For example, process 1400 may initialize the counter by making the value of the counter zero. At step 1404, process 1400 retrieves an array of data fields for a user profile. For example, the array of data fields for a user profile may correspond to array 1600 (FIG. 16).

At step 1406, process 1400 retrieves the next media content interest data field from the user profile array. In some embodiments, the user profile array (e.g., array 1600 (FIG. 16)) may have several data fields corresponding to the interest of the user (e.g., data fields 1604, 1606, 1608, 1610, and 1612 (FIG. 16).

At step 1408, process 1400 inputs the data field value retrieved in step 1406 into a database. The database may be located locally at user equipment 402, 404, and/or 406 (FIG. 4) or may be located at media guidance data source 418 (FIG. 4) and accessed via the communications network 414 (FIG. 4). The database may contain all related media content listings retrieved from all available sources (e.g., as described in process 900 (FIG. 9)).

At step 1410, process 1400 filters the database based on the value inputted into the data field. In some embodiments, the database may be structured as a lookup table, which is filtered according to the values that are inputted into the table. For example, the lookup table may contain a wide range of information on the title, release date, actor, director, awards received, production company, genre, budget, and/or any other factor used to describe a media asset (e.g., as shown in data structure 1700). As information is inputted into the database, the information presented may be filtered to show only information, which corresponds to the inputted information. For example, data structure 1704 (FIG. 17B) may be the result of filtering data structure 1700 (FIG. 17A) according to media assets featuring the actor, “Phil Thomas.”

At step 1412, process 1400 determines whether or not the counter value equals a maximum counter value. If the value does not equal the maximum counter value, process 1400 will add one increment to the counter at step 1414 and return to step 1406. For example, if the first iteration analyzed the first data field containing media content interests in an array of data fields (e.g., data field 1604 of array 1600 (FIG. 16), then the next data field analyzed may be the next data field containing media content interests in the array of data fields (e.g., data field 1608 of array 1600 (FIG. 16)).

If the counter value equals the maximum counter value at step 1412, process 1400 may present the related media content listings of most interest to the user (e.g., related media content listings 524 and 526 (FIG. 5B)) at step 1416.

It is contemplated that the steps or descriptions of FIG. 14 may be used with any other embodiment of this disclosure. In addition, the steps and descriptions described in relation to FIG. 14 may be done in alternative orders or in parallel to further the purposes of this disclosure. For example, each of these steps may be performed in any order or in parallel or substantially simultaneously to reduce lag or increase the speed of the system or method.

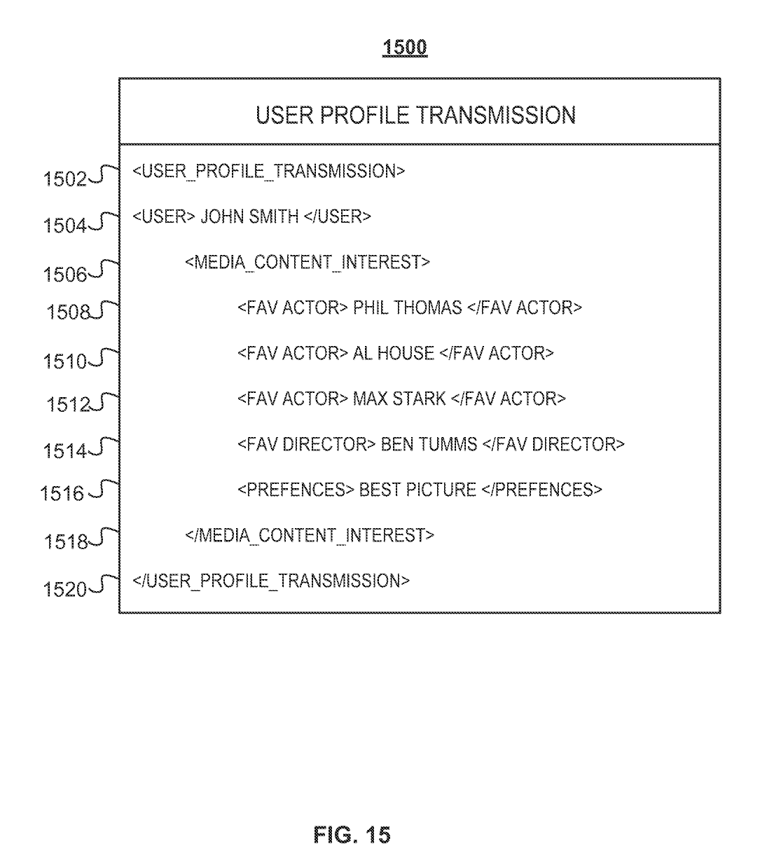

FIG. 15 shows an exemplary data structure for user profile info30608039_{—}1rmation in accordance with some embodiments of the disclosure. FIG. 15 shows data structure 1500, which may be transmitted to the media guidance application by content source 416 (FIG. 4), media guidance source 418 (FIG. 4), or any other source accessible via the communication network 414 (FIG. 4). Data structure 1500 may be transmitted to the media guidance application in metadata accompanying the media asset. In some embodiments, data structure 1500 may be received by control circuitry 304 (FIG. 3) to provide information to the media guidance application. For example, in some embodiments, user profile information received in data structure 1500 may provide, at least in part, the basis for determining the next trigger for which to provide related media content as described in relation to step 1112 of process 1100 (FIG. 11). It should be noted that the information presented in data structure 1500 is illustrative and is not meant to be limiting as to the amount or type of information that may be transmitted to the media guidance application.

Data structure 1500 contains several lines of code, which may be received by the media guidance application. Line 1502 indicates to the media guidance application the beginning of the user profile transmission file. Line 1504 indicates that the user is “John Smith.” Line 1506 indicates the beginning of media content interests that make up the user profile. Lines 1508, 1510, 1512, 1514, and 1516 describe the media content interests of the user profile. Line 1518 indicates to the media guidance application the end of the media content interests, and line 1520 indicates the end of the user profile transmission file.

Line 1508 indicates the user's favorite actor is “Phil Thomas.” This information may be used by the media guidance application to personalize the related media content listings that appear on the display. For example, in some embodiments, the media guidance application may access user profile information to determine what entity should have related media content listings appear on the display (e.g., as described by process 1100 (FIG. 11)).

In some embodiments, the lack of screen space and the speed of the crawl of the credits may prevent all of the entities in the credits from having related media content listings shown. Therefore, the media guidance application may prioritize the entities for which related media content listings are shown based on the user profile. For example, in some embodiments, display 512 (FIG. 5B) may relate to a display for which the user profile of data structure 1500 was used. Based on the information in data structure 1500, the media guidance application determined that “Phil Thomas” is of more interest to the user than “Bill Jones” (e.g., as indicated by line 1508), which precedes “Phil Thomas” in credits 516 (FIG. 5B). Therefore, the related media content listings (e.g., related media content listings 524 and 526 (FIG. 5B)) relate to “Phil Thomas,” instead of “Bill Jones.”

In some embodiments, after the trigger for “Phil Thomas” expires, the media guidance application may access the user profile again. Line 1510 indicates that the user may also be interested in related media content listings for “Al House.” Therefore, the next set of related media content listings may be for “Al House” as shown in display 750 (FIG. 7).

In some embodiments, the information in the user profile may also determine the particular related media content listings that are shown on the display. For example, based on the user profiles, the media guidance application may order the related media content listings (e.g., related media content listings 524 and 526 (FIG. 5B)) such that related media content listings which are more likely to interest the user are displayed first (e.g., as shown in FIG. 5A). In some embodiments, the media guidance application may arrange the related media content listings such that the listing more likely to interest the user is displayed more prominently (e.g., in front of other listings) than the remaining listings (e.g., as shown in FIG. 8A).

FIG. 16 shows an exemplary data structure for a compilation of data associated with a user profile in a media asset in accordance with some embodiments of the disclosure. For example, the data structure shown in FIG. 16 may represent the information processed or scanned in step 1112 (FIG. 11) of process 1100 (FIG. 11). In some embodiments, each user may have a corresponding data structure (e.g., array 1600) which describes the media assets and entities of most interest to the user. It should be noted that the information presented in array 1600 is illustrative and is not meant to be limiting as to the amount or type of information compiled in a user profile.

FIG. 16 shows array 1600. In some embodiments, array 1600 may be associated with a particular user or group of users (e.g., a family). Array 1600 contains data field 1602. Data field 1612 indicates the location of the user profile “John Smith's Webpage.” For example, in some embodiments, the media guidance application may access user profiles located any place accessible from communication network 414 (FIG. 4), including from websites (e.g., a social network web-site). In some embodiments, the media guidance application may also store profile information in user equipment 402, 404, and 406 (FIG. 4), media guidance source 418 (FIG. 4), or any place accessible via the communications network 414 (FIG. 4). In some embodiments, the array 1600 may correspond information received via data structure 1500 (FIG. 15).

Data field 1604, 1606, and 1608 indicate the favorite actors of the user. For example, in some embodiments, data fields 1604, 1606, and 1608 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets featuring the actor “Phil Thomas.” Upon locating “Phil Thomas” in an array (e.g., array 1000), the media guidance application may use the other data fields in the array (e.g., a data field corresponding to the title of the media asset) to construct a related media content listing (e.g., related media content listings 814 and 816 (FIG. 8A). The related media content listing may then be displayed during the credits of a media asset featuring “Phil Thomas” (e.g., display 800 (FIG. 8A)).

Data field 1610 indicates the name of the user's favorite director, “Ben Tumms.” Data field 1610 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets directed by “Ben Tumms.” Upon locating “Ben Tumms” in an array (e.g., array 1000), the media guidance application may use the other data fields in the array (e.g., a data field corresponding to the title of the media asset) to construct a related media content listing (e.g., related media content listings 814 and 816 (FIG. 8A). The related media content listing may then be displayed during the credits of a media asset directed by “Ben Tumms” (e.g., display 800 (FIG. 8A)).

Data field 1612 indicates the user may prefer media assets that were awarded “Best Picture.” Data field 1612 may be used by the media guidance application to generate related media content listings (e.g., related media content listings 524 and 526 (FIG. 5B)) in a display (e.g., display 512 (FIG. 5B)). In some embodiments, the media guidance application may perform a search of data fields across a plurality of arrays. For example, the media guidance application may search for all media assets awarded “Best Picture.” Upon locating “Best Picture” in a data field corresponding to awards received by the media asset, the media guidance application may use the other data fields in the array (e.g., a data field corresponding to the title of the media asset) to construct a related media content listing (e.g., related media content listings 814 and 816 (FIG. 8A).

It should be noted that the information presented in array 1600 is illustrative and is not meant to be limiting as to the amount or type of information that may be stored by the media guidance application. The information contained in array 1600 may also be used to filter the numerous related media content listings retrieved by the media guidance application from various sources (e.g., as described in relation to process 900 (FIG. 9)).

FIGS. 17A through 17C shows exemplary data structures filtered for related media content listings according to a user profile in accordance with some embodiments of the disclosure. FIG. 17A shows data structure 1700. Data structure 1700 may contain all the related media content listings. It should be noted that the information presented in data structure 1700 is illustrative and is not meant to be limiting as to the amount or type of information that may be stored by the media guidance application. In some embodiments, data structure 1700 may be a lookup table, where entities are organized in alphabetical order. Row 1702 indicates the related media content interests most likely to be of interest to the user based on the user profile. For example, the related media content interest features the actor, director and award received known to be of interest to the user as indicated in data fields 1604, 1610, and 1612 (FIG. 16), respectively.

FIG. 17B shows data structure 1704, which is filtered for “Phil Thomas.” In some embodiments, the filtering of data structure 1700 (FIG. 17A) to produce data structure 1706 (FIG. 17B) may correspond to step 1410 (FIG. 14)). FIG. 17C shows data structure 1706, which is filtered for particular listings that feature “Phil Thomas” and are likely to be of interest to the user. For example, the listings shown in data structure 1706 include listing which contain multiple indicia (e.g., entries corresponding to data fields in the user profile) of the user interest.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted, the systems and/or methods described above may be applied to, or used in accordance with, other systems and/or methods.

1. A method for providing media content listings during credits of a media asset, comprising:
compiling media content listings related to at least one of the entities in the credits of the media asset;
storing, on a database, the related media content listings;
receiving information associated with a display of the at least one of the entities in the credits on a first display screen;
in response to receiving the information, retrieving the related media content listings from the database;
synchronizing a display of the related media content listings to the display of the at least one of the entities in the credits; and
without user input, presenting the synchronized display of the related media content listings on the first display screen simultaneously with the at least one of the entities in the credits.

2. The method of claim 1, wherein presenting the synchronized display of the related media content listings on the display screen simultaneously with the at least one of the entities in the credits, further comprises presenting the at least one of the entities in the credits on a second display screen.

3. The method of claim 1, further comprising:
retrieving a location of media content associated with the related media content listings displayed on the first display screen;
establishing a link between the location of the media content and the related media content listing, wherein selection of the related media content listing accesses the media content.

4. The method of claim 1, further comprising configuring the related media content listings to be navigable by a user.

5. The method of claim 4, further comprising pausing the display of the at least one of the entities in the credits, while the user is navigating the related media content listing.

6. The method of claim 1, further comprising removing the related media content listings when the at least one of the entities in the credits is no longer displayed on the first display screen.

7. The method of claim 1, further comprising adjusting the position of the credits on the first display screen to present the synchronized display of the related media content listings.

8. The method of claim 1, further comprising presenting an overlay comprising the related media content listings over the credits.

9. The method of claim 1, wherein the information associated with the display of the at least one of the entities in the credits on a first display screen is a credit trigger.

10. The method of claim 1, wherein the information associated with the display of the at least one of the entities in the credits on the first display screen is a mapping of a location of the at least one of the entities in the credits in the media asset.

11. A system for providing media content listings during credits of a media asset, comprising:
a server configured to compile media content listings related to at least one of the entities in the credits of the media asset;
a database configured to store the related media content listings;
control circuitry configured to:
receive information associated with a display of the at least one of the entities in the credits on a first display screen;
retrieve the related media content listings from the database in response to receiving the information;
synchronize a display of the related media content listings to the display of the at least one of the entities in the credits; and
transmit instructions to present, without user input, the synchronized display of the related media content listings on the first display screen simultaneously with the at least one of the entities in the credits.

12. The system of claim 11, wherein the control circuitry is further configured to transmit instructions to present, without user input, the at least one of the entities in the credits on a second display screen.

13. The system of claim 11, wherein the control circuitry is further configured to:
retrieve a location of the media content associated with the related media content listings displayed on the first display screen;
establish a link between the location of the media content and the related media content listing, wherein selection of the related media content listing accesses the media content.

14. The system of claim 11, wherein the control circuitry is further configured to navigate the related media content listings on the first display screen.

15. The system of claim 14, wherein the control circuitry is further configured to pause the display of the at least one of the entities in the credits if the related media content listings are being navigated.

16. The system of claim 11, wherein the control circuitry is further configured to remove the related media content listings when the at least one of the entities in the credits is no longer displayed on the first display screen.

17. The system of claim 11, wherein the control circuitry is further configured to adjust the position of the credits on the first display screen to present the synchronized display of the related media content listings.

18. The system of claim 11, wherein the control circuitry is further configured to present an overlay comprising the related media content listings over the credits of the media asset.

19. The system of claim 11, wherein the information associated with the display of the at least one of the entities in the credits on a first display screen is a credit trigger.

20. The system of claim 11, wherein the information associated with the display of the at least one of the entities in the credits on the first display screen is a mapping of a location of the at least one of the entities in the credits in the media asset.

21-30. (canceled)
